(19) United States
(12) Patent Application Publication
(10) Pub. No.: US 2012/0095841 A1
(43) Pub. Date: Apr. 19, 2012

(54) Electronic Marketplace for Energy

(76) Inventors: Douglas Luckerman, Lexington, MA (US); Alan Lehmann, Lexington, MA (US)

(21) Appl. No.: 13/272,580

(22) Filed: Oct. 13, 2011

Related U.S. Application Data
(60) Provisional application No. 61/393,593, filed on Oct. 15, 2010.
(60) Provisional application No. 61/478,885, filed on Apr. 25, 2011.

(51) Int. Cl. G06Q 30/02

(52) U.S. Cl. 705/14.66

(57) ABSTRACT

A computer-implemented system for consumers and suppliers of energy provides an on-line marketplace where energy consumers may learn about their options for obtaining energy and enter contracts with energy suppliers. Energy suppliers may use the system to learn about other suppliers as well as consumers, and to extend offers to consumers for the provision of energy. The system gathers data on suppliers and consumers from numerous reliable sources, and thus provides a content-rich environment that facilitates consumer choice in the selection of energy suppliers.

### CROSS-REFERENCES TO RELATED APPLICATIONS

Priority is claimed to U.S. Provisional Application No. 61/393,593, filed Oct. 15, 2010, and U.S. Provisional Application No. 61/478,885, filed Apr. 25, 2011, which are incorporated herein by reference in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO A “SEQUENCE LISTING,” A TABLE, OR A COMPUTER PROGRAM LISTING APPENDIX

Not Applicable.

### BACKGROUND OF THE INVENTION

1. Field of the Invention

This invention relates generally to electronic commerce, and, more particularly, to computerized applications for providing online marketplaces where consumers and suppliers of energy may obtain information about one another and pursue commercial relationships.

2. Description of Related Art

In the decade or more since electricity generation became deregulated in states across the United States, competitive suppliers of electricity have been unable substantially to penetrate the residential energy market. This is the case even when competitive suppliers offer to sell electricity at rates below those of incumbent local utilities. As a general example, in some states (e.g., Maine) competitive suppliers of electricity serve only about 5% of the residential market. In other states (e.g., Connecticut) competitive suppliers serve approximately 41% of the market. In general, across all the deregulated states, competitive suppliers serve an average of only about 10-12% of the total residential electricity market.

In recent years, residential and commercial consumers alike have grown accustomed to conducting household and commercial business over the Internet. We have recognized that the Internet has great potential for bringing together energy consumers and energy suppliers to promote competition among suppliers and to increase penetration of competitive energy suppliers into residential and consumer markets.

Prior Internet applications, (e.g., www.saveonenergy.com), have attempted to provide energy consumers with information about competitive suppliers. However, these applications are essentially merely directories. They provide lists of suppliers, links to supplier websites, and very limited information, such as energy cost and payment terms. In general, in these prior art systems, once a customer selects a supplier to switch to, they are then sent to that supplier's website to learn more of the important details of the offer and then have to reenter any information that they entered on the prior art website. Consumers are left to acquire more detailed information about the various suppliers on their own, with the result too often being that consumers, armed with little information about competitive suppliers, decide to do nothing.

There is a need, therefore, for an online marketplace that provides consumers with more detailed information about suppliers to enable them to more easily make informed decisions and to better facilitate the formation of contracts between consumers and suppliers.

### BRIEF SUMMARY OF THE INVENTION

The inventors hereof have recognized and appreciated that an experience of energy consumers and/or suppliers may be improved through a computerized application accessible to energy consumers over a computer network, such as the Internet. In certain illustrative embodiments, the application may receive detailed information about products that competitive suppliers are selling, store that information, and present that information to energy consumers that are users of the application. The application may present to consumers the competitive suppliers serving their geographic region along with detailed information about the products the suppliers are offering. The consumer can then select the product that best meets their needs. The application may then walk the consumer users through a registration process to sign up with the selected suppliers. In one example, this may be done without having to leave the application. In certain illustrative embodiments, the application may also store data about consumers, including, for example, property information, current suppliers, energy costs, energy consumption, and/or payment history. In certain illustrative embodiments, the application may receive information about consumers' billing entities, such as their electric utilities. The application may contact the billing entities and obtain certain consumer data directly therefrom. The consumer data may be distributed to competitive suppliers (i) to solicit tailored quotes based on the consumer data, (ii) to calculate potential savings that consumers could experience by switching to different suppliers, and/or (iii) to facilitate a contracting process between consumers and selected suppliers, by automatically providing previously collected consumer data as part of the processes for registering consumers with selected suppliers. In certain illustrative embodiments, the application may include a broker interface to be used by energy brokers. The application may respond to instructions from brokers to group together different properties and/or power meters, gather consumer data associated with the different properties and/or power meters in the resulting group, and receive tailored quotes from different suppliers for the provision of energy to the group as a whole. In certain illustrative embodiments, the application may include a supplier interface for allowing supplier users of the application to view aggregated data about consumers as they relate to particular suppliers, such as sales acquisition and retention performance.

In general, in an embodiment, the application can aggregate usage data via data access methods (e.g., scraping, web services, file transfers) from several commercial locations in different geographies. The data can be analyzed and presented in several views (e.g., by utility, state, consolidated view) without the need for further processing by the consumers or energy suppliers. The application can be delivered to users over the internet as a SaaS product.

In accordance with an illustrative embodiment, a computer-implemented method for facilitating relationships among energy consumers and energy suppliers includes operating at least one processor to perform a method. The method includes communicating, over a computer network, with a consumer, communicating, over the computer network, with a billing entity serving the consumer, and retrieving, over the computer network, consumer data from the billing entity serving the consumer. The consumer data pertains to at least one of energy usage, timing of energy usage, and payment history. The method further includes providing the consumer with a list of energy suppliers and associated contract terms for the provision of energy. At least some of the contract terms are based on the retrieved consumer data.

In accordance with another illustrative embodiment, a computer-implemented marketplace for energy consumers and energy suppliers includes a processor operatively connected to a computer network for communicating with consumers and suppliers over the computer network. The marketplace further includes at least one database storing information about consumers and suppliers and application code running on the processor with access to the at least one database. The application code includes at least one consumer module constructed and arranged to present to consumer users of the marketplace information from the at least one database pertaining to a plurality of suppliers. The application code further includes at least one supplier module constructed and arranged to present to supplier users of the marketplace information from the at least one database pertaining to a plurality of consumers and at least one billing entity module constructed and arranged to access, via the processor over the computer network, a billing entity of a consumer user of the marketplace, and to retrieve consumer data therefrom pertaining to the consumer user of the marketplace.

In accordance with yet another illustrative embodiment, a non-transitory computer readable storage medium has computer-executable instructions which, when executed, carry out a method of facilitating relationships among energy consumers and energy suppliers. The method includes communicating, over a computer network, with a billing entity of an energy consumer, receiving, from the billing entity over the computer network, consumer data pertaining to the energy consumer, and transmitting, over the computer network, at least a portion of the consumer data to at least one energy supplier.

### BRIEF DESCRIPTION OF THE SEVERAL VIEWS OF THE DRAWINGS

FIG. 1 is a general block diagram of a web application (WA) according to an illustrative embodiment of the invention and an environment in which the WA may be used;

FIG. 2 is a block diagram of the WA of FIG. 1;

FIG. 3 is a block diagram of application code shown of FIG. 2;

FIGS. 4-9 are exemplary web pages of the WA, which may be accessed by consumer users of the WA;

FIGS. 10-11 are exemplary web pages of the WA, which may be accessed by supplier users of the WA;

FIG. 12 is a flowchart showing an exemplary process for estimating a monetary savings that a consumer user of the WA could experience by switching to a different energy supplier;

FIG. 13 is a flowchart showing an exemplary process for estimating a consumer user's savings by switching to a different supplier based on informed estimates of the consumer's energy usage or based on actual usage data;

FIG. 14 is a flowchart showing an exemplary process whereby the WA may make tailored offers to consumers for the provision of energy on behalf of suppliers;

FIG. 15 is a flowchart showing an exemplary process whereby the WA may create an account on behalf of a consumer on the website of the user's utility or other billing entity;

FIG. 16 is a flowchart showing an exemplary process whereby the WA may log on to the website of a billing entity and obtain consumer data therefrom;

FIG. 17 is a flowchart showing an exemplary process whereby the WA may cause a contract to be formed between a consumer user and a supplier;

FIGS. 18-25 are exemplary web pages of the WA, which may be accessed by consumer users of the WA;

FIGS. 26-29 are exemplary web pages of the WA, which may be accessed by supplier users of the WA;

FIGS. 30-31 are exemplary consumer dashboard web pages of the WA;

FIG. 32 is a block diagram of a contract renewal manager code segment;

FIG. 33 is a block diagram of an at risk manager code segment;

FIG. 34 is a block diagram of a cancelation manager code segment;

FIG. 35 is a block diagram of an acquisition manager code segment;

FIG. 36 is a block diagram of a customized marketplace code segment;

FIG. 37 is a conceptual diagram of a supplier product sales funnel object; and

FIG. 38 is a conceptual diagram of a winning and losing sales comparison code segment.

### DETAILED DESCRIPTION OF THE INVENTION

According to the various illustrative embodiments hereof, a computer-implemented marketplace for consumers and suppliers of energy is provided in the form of a web application (WA) 110, i.e., a computer-implemented software application accessible over the world-wide web or other computer network.

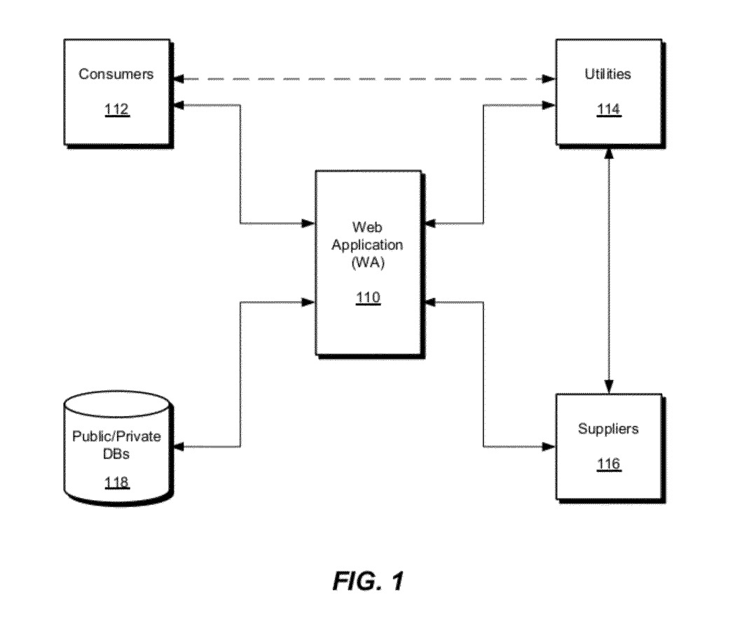

FIG. 1 shows an example of the WA 110 in its intended environment. The WA 110 may be operatively connected to communicate with consumers 112, utilities 114 (e.g., billing entities), suppliers 116, and various public and/or private databases 118. Connections may be made via a computer network, such as the Internet. The WA may preferably be implemented as part of a web server environment connected to the Internet and accessible at a particular uniform resource locator (URL), (e.g., www.currentchoice.com). Consumers 112 and suppliers 116 may access the WA 110 using Internet browsers on respective computers connected to the Internet. In response to page requests from consumers and/or suppliers, the WA 110 may transmit web pages over the Internet, which may be viewed on the respective consumers' computers via their associated browsers.

In the following example, the WA is described in connection with the provision of electrical energy. However, the WA may be used in connection with other forms of energy, such as natural gas, propane, and heating oil.

The term “consumers” as used herein includes purchasers and potential purchasers of energy. Consumers may be individuals, businesses, organizations, associations, or groups of any of the foregoing that purchase or wish to purchase energy. They may represent themselves or be represented by other parties, such as energy brokers. Energy brokers that use the WA may be regarded as consumers. This is the case even if a broker is paid by a supplier or other party. The term “consumer users” is also used herein to indicate consumers who are also users of the WA 110.

“Suppliers” as used herein include parties that generate energy and/or that buy and sell energy on the open market. Consumers typically enter contracts with suppliers for the provision of energy. The suppliers generate or otherwise obtain energy and provide energy to the consumer under terms of the respective contracts. The term “supplier users” is also used herein to indicate suppliers who are also users of the WA 110.

“Utilities” as used herein include parties responsible for delivering energy to consumers. In general, in deregulated electrical energy markets within the United States, utilities install, read, and maintain power meters, provide and maintain poles and wires through which energy is transmitted to consumers, bill consumers for their energy usage, and receive payments from consumers. In some states (e.g., Texas), these functions are provided by an energy supplier. Payments received are delivered to respective suppliers with which the consumers have contracts. Utilities generally serve consumers on a geographical basis, i.e., one utility generally serves all energy consumers within a particular county or zip code, regardless of the fact that different consumers within that geographical area may have contracts with different suppliers.

Utilities generally have their own web applications, which consumers may typically access. Once consumers register with those web applications, they may log on to view various consumer data particular to their accounts. In general, the scope of consumer data made available varies from utility to utility but generally includes the consumers' bills, energy costs, energy usage, designated suppliers of energy, last meter read dates, and payment methods. Is some regions (e.g., Texas), the utility maintains usage information for an address (e.g., ESID) and information relating to the presence of a smart meter. Billing and payment history is generally maintained by the supplier.

Some states within the United States, and certain locations within countries other than the U.S., do not follow this deregulated scheme. For example, in Texas, utilities collect energy usage information and transmit that information to suppliers. Suppliers then bill consumers directly. In Texas, both suppliers and utilities generally have web applications. Consumers may log onto their accounts on the supplier-run web applications to view their consumer data. The consumer data available from suppliers in deregulated states may include consumers' bills, energy costs, energy usage, last meter read dates, and payment methods.

Therefore, both utilities and suppliers may act as “billing entities” for consumers, i.e., parties that bill consumers for the provision of energy. In deregulated states, the billing entity is typically the utility; in non-deregulated states, it may be either the utility or the supplier. The billing entity may also be an agent of a utility or the supplier, a separate business or association, or a governmental office or body. In any case, the billing entity generally has a web application to which consumers may log on to view their consumer data.

Various public and/or private databases 118 may be accessible to the WA 110 over the Internet. Examples of the databases 118 may include the Energy Information Association (EIA) in the United States, energy usage databases outside the United States, and various LexisNexis databases. The EIA maintains data pertaining to average energy consumption organized by geographical area (e.g., state, county, or zip code). The WA 110 may use information from the EIA or similar entities outside the United States to estimate typical energy costs in different geographical areas and to estimate savings that consumers might hope to enjoy by switching to less expensive suppliers. LexisNexis databases store information pertaining to specific properties, including address, number of residents, square footage, number of rooms, number of bathrooms, year built, method of construction (e.g., brick or wood frame), and whether the home has air conditioning. In an embodiment, such information can be mined and compared to determine the relative energy efficiency between similarly constructed homes. The WA 110 may use these types of information from LexisNexis to provide accurate estimates of energy usage and to provide tailored recommendations to consumers for improving energy efficiency. For example, the WA 110 may infer from the year a residence was built that it has high or low quality insulation. It may then provide consumers whose residences were built prior to a certain year with suggestions that their insulation be upgraded. The public/private databases 118 therefore provide the WA 110 with specific information about consumers and their properties and thus enable the WA to provide better service to consumers.

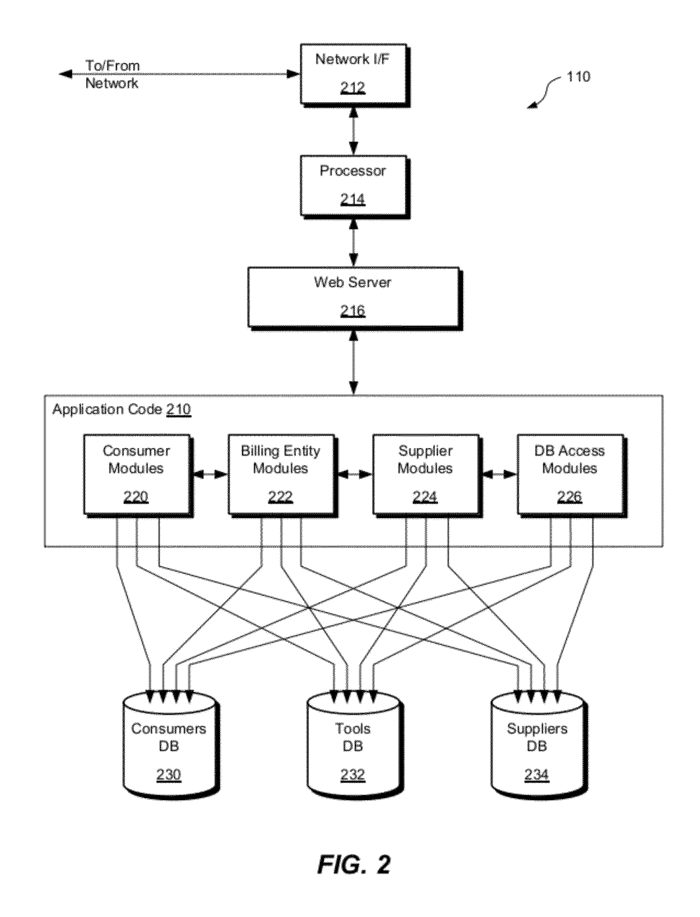

FIG. 2 shows an exemplary structure of the WA 110. The WA 110 may include a processor 214 having web server software 216 and a network interface 212. The network interface 212 allows the WA to communicate over a computer network (e.g., the Internet) with consumers 112, utilities 114, suppliers 116, and public/private databases 118. The WA may include application code 210, which may be executed by the processor 214 under direction of the web server 216. The application code 210 may have access to at least one database. Nominally, three databases are provided, i.e., a consumers database 230, a tools database 232, and a suppliers database 234; however, these databases may be combined or more finely divided, as desired during system implementation.

The consumers database 230 stores information about individual consumer users of the WA 110. The information stored may include, for example, information about the consumers' residences, payment histories, identities of suppliers used by the consumers, and contract terms with suppliers. The tools database 232 may include data used by the WA 110 for various tools and features that the WA provides. Examples may include tables associating IP addresses with zip codes or other geographic regions, which the WA may use to identify a consumer's location, and tables associating utilities with the zip codes or other geographic regions they serve, which allow the WA to identify a consumer's utility. The suppliers database 234 includes information about different suppliers, including, for example, their various products, contract rates and terms, whether they offer fixed price contracts, variable price contracts, or both, the geographic areas they serve, links their websites, and other contact information. It may also include account information about supplier users of the WA.

The application code 210 is seen to include consumer modules 220, billing entity modules 222, supplier modules 224, and database access modules 226. These groups of modules may operate in coordination with one another and with the consumers database 230, tools database 232, and suppliers database 234. Each group of modules may be operatively connected to each database. In particular, consumer modules 220 may be operatively connected to the consumers database 230 and the suppliers database 234, thus providing a structure that gives consumers 112 access to information about both themselves and the various suppliers 116. Similarly, supplier modules 224 may be operatively connected to the suppliers database 234 and the consumers database 230, thus providing a structure that gives suppliers 116 access to information about both themselves and the various consumers 112.

The database access modules 226 manage communication with the public and/or private databases 118. These modules may include automated bots or other automated or semi-automated web tools for logging onto remote databases, performing searches, retrieving information, and storing information in the consumers database 230, tools database 232, and/or suppliers database 234.

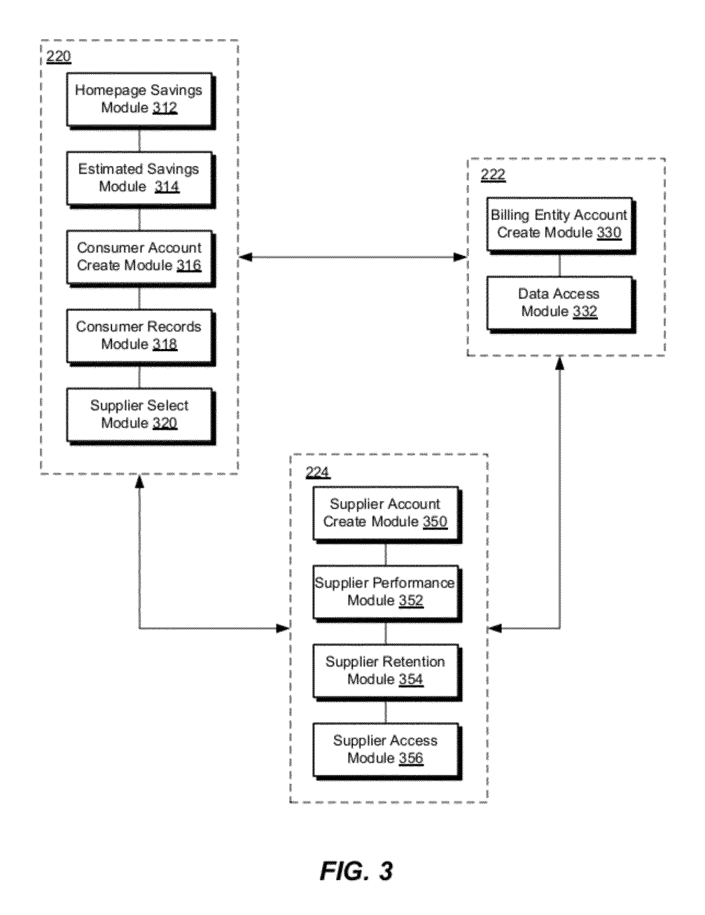

FIG. 3 shows the consumer modules 220, billing entity modules 222, and supplier modules 224 in more detail. The consumer modules 220, as shown in FIG. 3, are primarily directed to serving the needs of consumers. They may include the following:
Homepage savings module 312: calculates an estimated monetary savings that a consumer user could achieve by switching to a less expensive supplier of energy in the consumer user's geographical area;
Estimated savings module 314: calculates an estimated cost savings that a consumer user could expect to achieve based on energy usage and geographical information about the consumer user;
Consumer account create module 316: gathers user information and creates accounts for consumer users on the WA 110; user information obtained may also be used to create accounts for consumer users at their respective billing entities; in an embodiment, user authentication tests (e.g., CAPTCHA) from the billing entities site can be imaged and presented to the user in the WA site such that user can authenticate without leaving the WA site;
Consumer records module 318: organizes information about individual consumer users of the WA, including information about the consumer user's current supplier and plan, contract terms and conditions; the consumer user's activities on the WA, any messages or alerts sent or received by consumers using the WA; in an embodiment, a consumer can be presented with their past 12 months of energy usage; and
Supplier selection module 320: identifies suppliers within the geographical areas of respective consumers and ranks then based on desired criteria, such as energy cost; presents detailed information about suppliers and accepts consumer choices of desired suppliers.

The billing entity modules 222 are primarily directed to interactively communicating with billing entities and obtaining consumer data therefrom. They may include the following:
Billing entity account create module 330: gathers information about consumers and applies the information to create accounts on behalf of consumers on consumers' billing entities' websites; and
Data access module 332: logs onto billing entity accounts on behalf of consumers, reads pages, and collects consumer data from consumers' accounts at billing entities.
   The billing entity modules 222 thus interact with utilities and/or other billing entities to acquire consumer data. The consumer data may be stored in the consumer database 230 for later use by the WA 110. In an embodiment, a user account can be created on the billing entities' website without requiring the user to leave the WA interface. That is, the WA creates the account with the billing entity in the background of the operation of the WA. The data access module can be configured to read the HTML tags within the billing entities' website and bring relevant data into the WA.

The supplier modules 224 are primarily directed to serving the needs of suppliers. They may include the following:
Supplier account create module 350: creates accounts for supplier users on the WA 110;
Supplier performance module 352: organizes and computes information pertaining to a supplier user's performance in attracting (i.e., acquiring) business from consumers;
Supplier retention module 354: organizes and computes information pertaining to a supplier user's ability to retain business from existing or previous consumers; and
Supplier access module 356: obtains information from suppliers, such as products, rates, promotions; rules for offering promotions to customers based on customers' energy usage, payment history, and other factors. May include a data interface for transferring data from supplier to WA 110 on a regular basis or in response to particular events. The data interface may involve transfers of XML files, web services, email, spreadsheet delivered by email, FTP, EDI, and/or comma delimited files, for example.

The various modules that make up the application code 210 may take a variety of forms, the particularities of which are not critical to the invention. For example, “modules” may be discrete software constructs, such as files, although this is not required. Alternatively, modules may be provided as different portions of software within one or more software files, functions, or subroutines. Some modules may include both user interface code and data processing code, in the form of web pages. Other modules may be provided without user interface code or without data processing code. Considering the wide variety of implementation schemes, it should be understood that the term “module” as used herein refers to a collection of software instructions that perform a designated function and is not constrained to any particular organizing structure.

The application code 210 may be written in any computer language, or computer languages, that taken as a whole allow communication with users over a computer network, such as the Internet. Some examples of suitable languages include HTML, ASP, ASP.NET, JSP, PHP, Java, PERL, and Flash.

The WA 110 may be implemented using a single computer or with multiple computers. The computer or computers may be physical machines or virtual machines. The elements shown in FIG. 2 may be located together on the same machine or may be distributed among different machines.

The processor 214 may preferably be a general-purpose processor or server. It preferably runs a commercially available operating system, such as Windows™, MAC OS, Unix, or GNU/Linux, for example. The web server 216 may be of any suitable type, such as Microsoft IIS (Internet Information Services) on Windows™, Apache Tomcat on Unix, or TUX on GNU/Linux.

The application code 210 and databases 230, 232, and 234 are preferably stored in files on a hard drive, flash drive, optical storage medium, or the like, which is accessible to the processor 214. The application code 210 and databases 230, 232, and 234, or portions thereof, may be read into a memory (not shown) of the processor during execution of the application code 210 by the processor 214.

The databases 230, 232, and 234 may be relational databases, such as Oracle or Microsoft SQL Server. Alternatively, the databases may be other types of files, or collections of files, such as spreadsheets, comma-delimited text files, or XML files. The databases may exist as data structures within the application code 210. No particular structure is required of the databases, other than that they permit data to be stored in an organized manner.

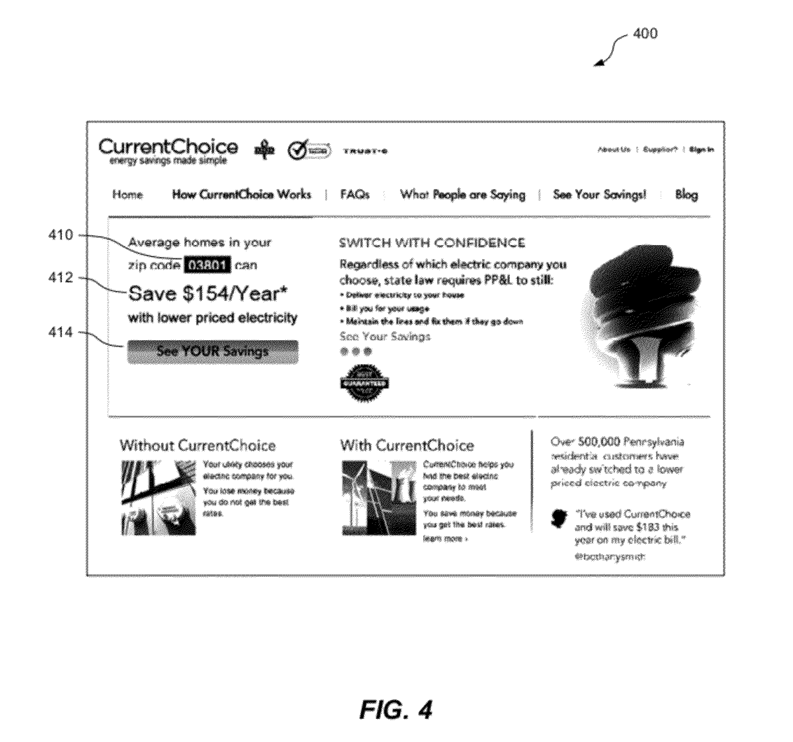

FIGS. 4-11 show various web pages of the WA 110. Each of these web pages may be associated with one or more of the modules of the application code 210. Users may download the web pages from the WA 110 over the Internet and view them on their client machines. The client machines may be conventional computers, such as personal computers, Macintosh computers, workstations, or terminals of mainframe computers. They may also be tablet computers, smart phones (e.g., Droid, iPhone, BlackBerry), PDA's, personal readers (e.g., Kindle or Nook), or other network connectable devices. Users may view the web pages using browsers, such as Microsoft Internet Explorer, Safari, Google Chrome, Firefox, and Opera, or using custom applications (apps) for use with portable devices.

FIG. 4 shows an exemplary home page 400 of the WA 110. The page 400 is preferably the first page that new consumer users of the WA 110 see when first visiting the WA. On this page, consumer users may take advantage of various features, learn about their options for switching energy suppliers, and obtain quick estimates of monetary savings they could experience by switching to different suppliers of energy. The home page 400 includes a field 410 for displaying and/or receiving a zip code of the consumer user and a savings indicator 412 for displaying a calculated estimated annual or monthly savings. The control 410 and indicator 412 operate in connection with the homepage savings module 312 to compute and display estimated savings. The estimated savings may be based on the cost of energy provided from the user's utility and a rough estimate of the user's energy usage, based on energy usage statistics of properties in the user's area. The home page 400 may also include a control, such as a button 414, which opens a page for presenting users with lists of competitive suppliers.

When clicking the button 414, the user may be presented with a page such as a pop-up window (not shown) asking the user for information. The window may ask, for example, that the user confirm the user's zip code and identify the user's utility company (in cases where there are more than one serving a particular area). The window may also request that the user check whether the user is interested in fixed-price energy contracts with suppliers, variable-price contracts, or whether there is no preference.

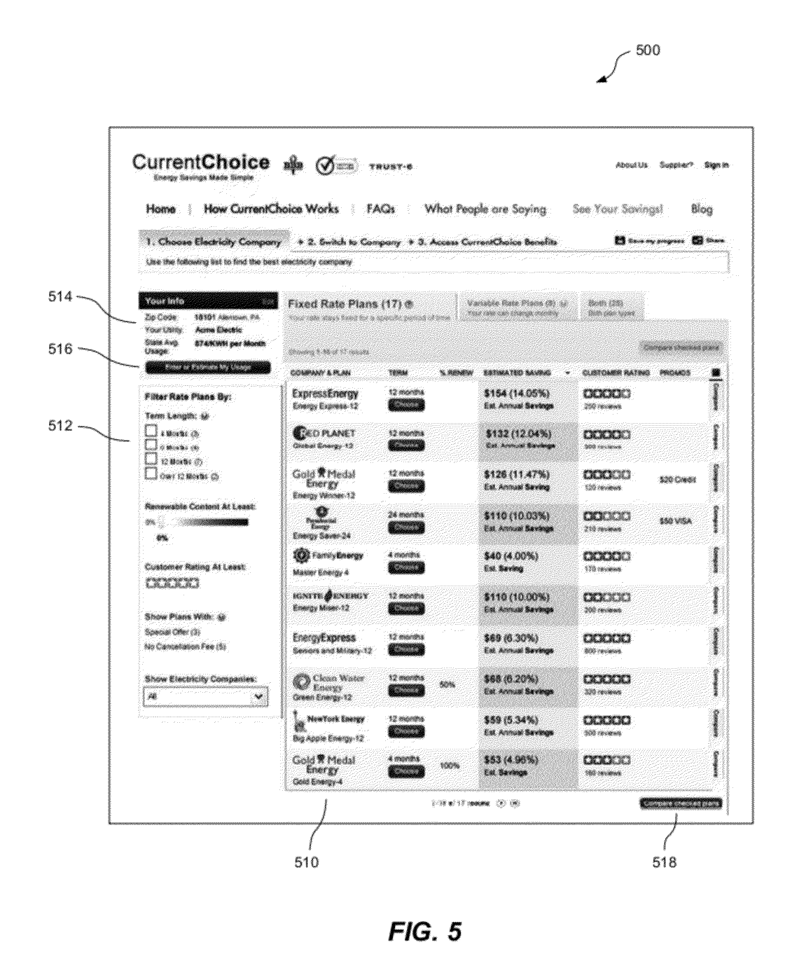

FIG. 5 shows an exemplary page 500, which may be displayed when the user enters information requested in the pop-up window and proceeds. The page 500 includes a list of energy plans 510 available from suppliers serving properties in the consumer user's geographical area (e.g., zip code). Information may be displayed for each plan listed, such as the supplier name and logo, plan name, contract term, estimated savings that could be obtained by switching to the plan, consumer ratings, and promotional offers. The page 500 may operate in coordination with the supplier select module 320, which in turn has access to the suppliers database 234. Plans listed on the page 500 are those from the suppliers database 234 that are available in the consumer user's geographical area (e.g., zip code). The list of the plans displayed may be sorted and/or filtered based on consumer preference. For example, a region 512 may allow the consumer user to filter the listed plans based on a preferred contract term length. Also, if a user entered a preference for fixed or variable contracts, the page 500 may limit the display to those plans only, or simply present the preferred contract types first, with the option to view other types (e.g., via different tabs). The page 500 may include a region 514 that displays information about the consumer user, such as the user's zip code, the user's utility, and the average energy usage of residents within the user's state. Users can compare different plans by checking the plans and operating a control, such as a button 518. Detailed head-to-head comparison information may then be presented. In addition, users can access detailed information about any particular plan on the list 510 by clicking an object on the screen (e.g., the plan name, supplier logo, or switch button).

The page 500 may also include a control, such as a button 516, for entering or better estimating the user's energy usage. Users may click this button, whereupon they may be prompted to supply information, which the WA 110 may use to calculate a better estimate of their energy usage than the one used on the home page 400. The button 516 and functions performed after it is clicked may operate in coordination with the estimated savings module 314. In an embodiment, the button 516 initiates a scraping process configured to acquire the customer's actual energy usage data from their utility. This process allows the consumer to create an account at their utility via the WA. The scraping process can then obtains the online account information such as the consumer's energy usage, the meter read date, their service address, their mailing address, payment history and current pricing. The page 500 may update values of estimated savings shown in the list 510 once the better estimate of the consumer's energy usage is obtained.

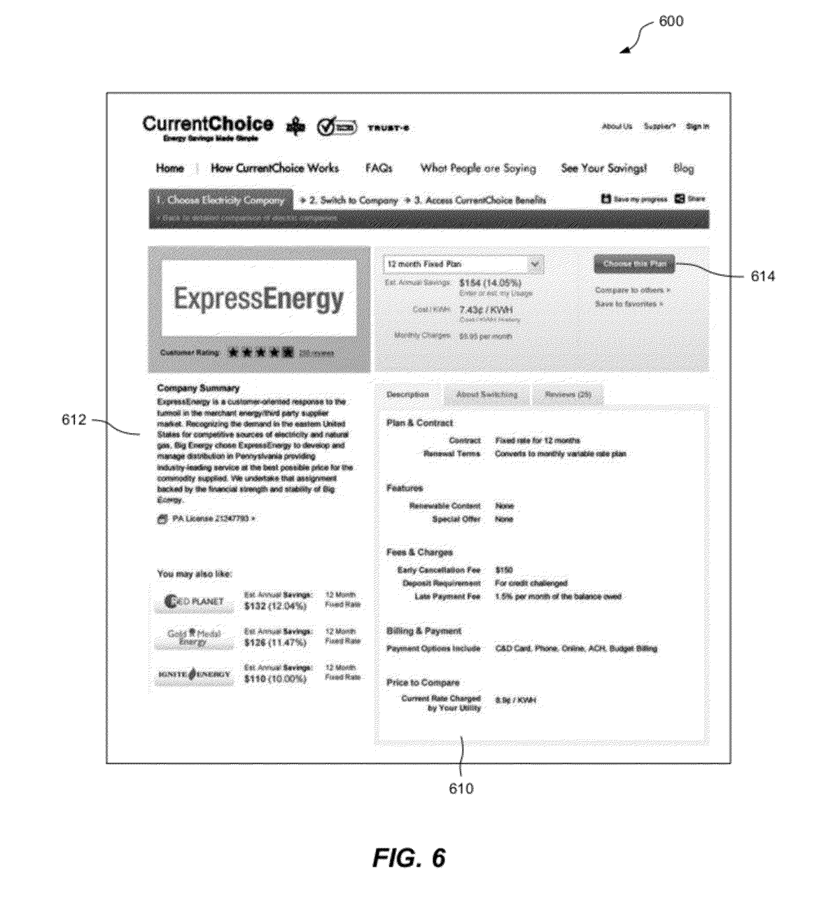

FIG. 6 shows an example of a page 600 that may be displayed when a user clicks on a plan name or logo in the region 510 of the page 500. The page 600 may be operated in coordination with the supplier select module 320. It includes a region 610 that displays detailed plan characteristics, including otherwise hard-to-find information like cancelation fees, late payment fees, and payment methods. The information displayed in the region 610 is preferably stored in the suppliers database 234. The page 600 may also include a region 612 that provides a supplier summary, customer ratings, and a copy of the supplier's state operating license. In an embodiment, the page 600 can include a multimedia object (e.g., flash, video) about the supplier. A control such as a button 614 is provided to allow users to select the displayed plan. To allow the switch to take place, the WA 110 may first require the consumer user to create an account.

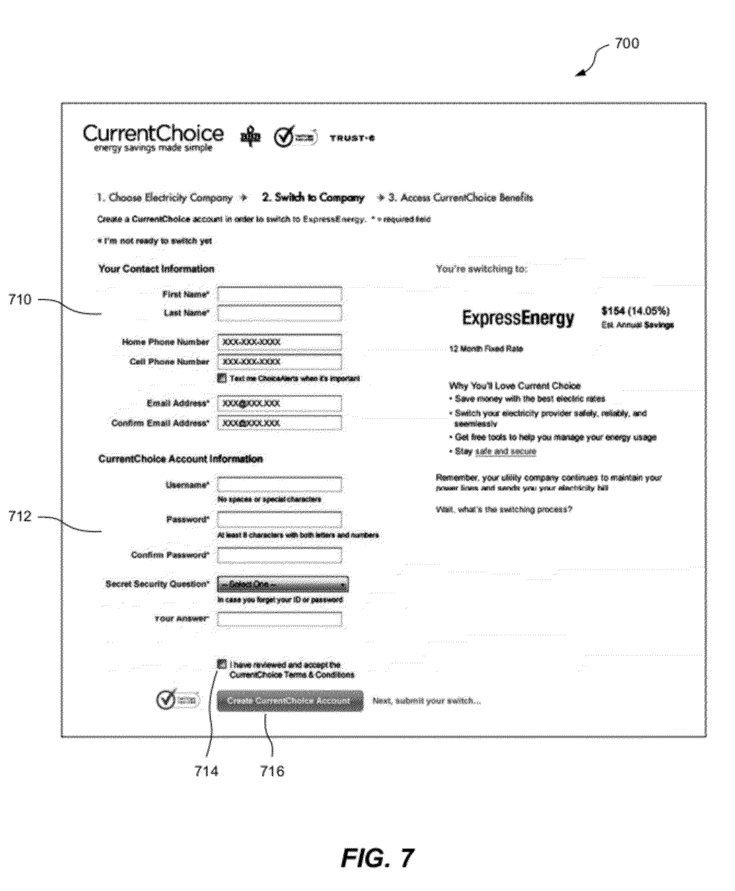

FIG. 7 shows an example of a page 700 for creating an account on the WA 110. The page 700 may be controlled by the consumer account create module 316. The page 700 may include a region 710, which allows users to input personal information, such as name, phone number(s), and email address. It may also include a region 712, which allows users to enter account information, such as username, password, and security question and answer. A control such as a checkbox 714 is presented, to receive a confirmation that the user has read the terms and conditions of use of the WA 110. The user inputs entered on the page 700 may be stored in the consumers database 230. The page 700 may include a control, such as a button 716. When this button is clicked, the consumer-entered information is applied to create a new account for the consumer on the WA 110. In an embodiment, the consumer can enter a future address (i.e., if they are moving) to help determine which energy supplier they should select. If their current supplier is available in the consumer's new address, the consumer can be provided an opportunity to transfer their existing contract to the new address.

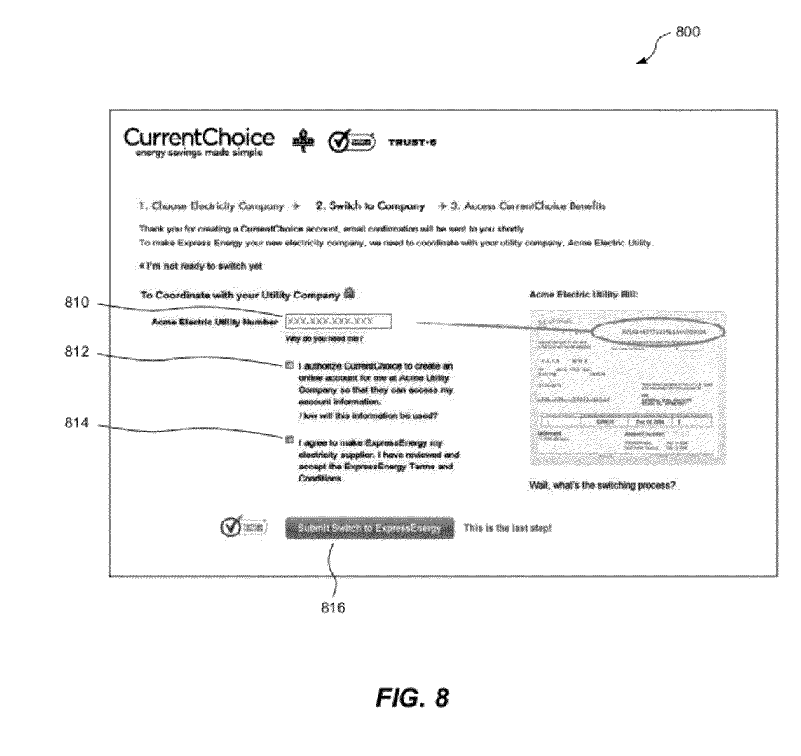

FIG. 8 shows a page 800, which may be displayed by the WA 110 when a user clicks the button 716 on the page 700. The page 800 is controlled by the billing entity account create module 330. It allows the consumer user to enter information relevant to the user's current billing entity (e.g., utility). The page 800 includes a field 810 where a consumer user may enter the account number of the user's billing entity account. This information may generally be obtained from a recent bill from the billing entity. The user may then authorize the WA 110, such as via a checkbox 812, to create an online account on behalf of the user at the billing entity's website. Also on this page, the user may confirm, such as via a checkbox 814, the user's intention to switch to a new supplier and/or plan. The user may also confirm that the user has reviewed and accepted terms and conditions that apply to the selected supplier and/or plan. Other UI objects such as model pop-up forms can be used to receive the user's confirmation of the terms and conditions. The user may then operate a control, such as a button 816, to submit the billing entity information and put the user's requested change into effect. In response to the user clicking this button, the WA 110 may automatically visit the billing entity's website and create an account there for the user. The WA may use the same personal and account information as were entered in the fields 710 and 712 of the page 700. Creating the account in this manner saves the user time and avoids data entry errors. Once logged on to the consumer's account, the WA 110 may put into effect the requested change to the newly selected supplier/plan. The WA 110 may also use the data access module 332 to retrieve consumer data about the consumer user from the billing entity's website. Retrieved consumer data may be stored in the consumers database 230 for later use by the WA 110.

Some consumers may have previously set up online accounts with their billing entities on their own. These consumers may be prompted to enter their account credentials, and the account creation process with the billing entity may be omitted.

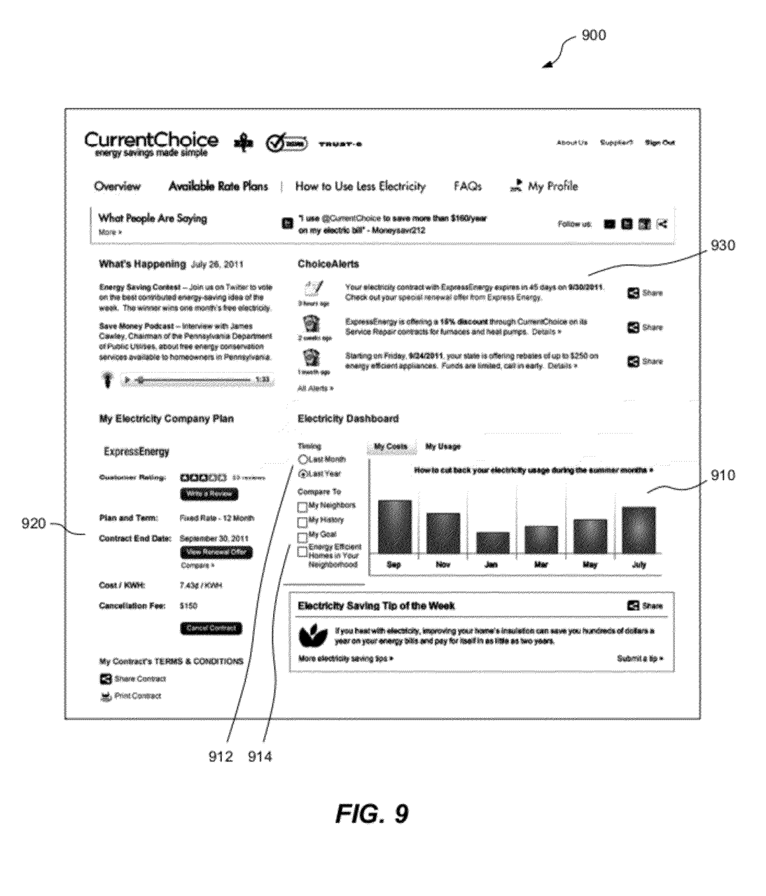

FIG. 9 shows an example of an overview page 900, which a consumer user may access by logging onto the WA 110 with the username and password established with the page 700. The page 900 may be controlled by the consumer records module 318, which may access and display information stored in the consumers database 230. The overview page 900 displays helpful information relevant to the user. It may include a region 910 that shows the user's energy usage over time. This region may include controls, such as radio buttons 912, for selecting timeframes over which to display energy usage. It may also include controls, such as checkboxes 914, for enabling the user to compare the user's own energy usage with that of the user's neighbors, past energy usage, an energy consumption goal, and/or the energy consumption of energy efficient homes in the user's neighborhood. Energy usage information for populating the region 910 may be obtained by the WA 110 using the data access module 332, which may acquire consumer data about the consumer user and other users from their respective billing entities. Energy consumption information in a user's area may also be obtained from public/private databases 118, such as LexisNexis. The page 900 may also include a region 920 that provides information about the consumer's currently selected plan and supplier. It may further include a region 930, which provides the user with alerts (e.g., ChoiceAlertsTM) about various subjects of relevance, such as impending contract expiration, available promotions and discounts, and opportunities to save energy.

In general, in an embodiment, the user can provide permission via the WA to acquire publically available information such as the square footage of their home, the year it was built, the number of people living there. Other information may be acquired as well. These characteristics can be indicators of the amount of energy a home is likely to consume. As a result, the indicators can be used to show apples-to-apples comparisons on energy usage between similar homes, and provide estimates as to energy conservation activity to undertake. For example, if a house was built in the 1940s, then it is likely that the walls are insulated with cotton. In general, cotton is far less effective insulation when compared to modern foam products. Thus, improved methods of insulation could be recommended. Further, in addition to providing a recommendation, the WA can provide the consumer with derivative benefits that are associated with the change. Staying with the insulation example, the WA can advise the consumer that if they live in a certain region (i.e., city, county, state) and they elect to replace their insulation, they may qualify for rebate. The WA can link the characteristics of the consumer's home to prioritized suggestions on energy savings steps to take (i.e., based on ROI, standards, best practices) and inform the consumer if there are any local programs that will help pay for the suggested energy savings activity.

In addition to providing pages to be used by consumers, the WA 110 may also provide pages to be used by suppliers. Suppliers may create accounts on the WA using a page or pages controlled by the supplier account create module 350. Once logged on, suppliers may view information about consumers and about themselves. This information may be drawn from the consumers database 230 and the suppliers database 234. In an embodiment, the suppliers can utilize the WA to create energy offers that can be made available to one or more consumers. For example, offers can be made available by region, by time, by credit history, energy usage, and other factors.

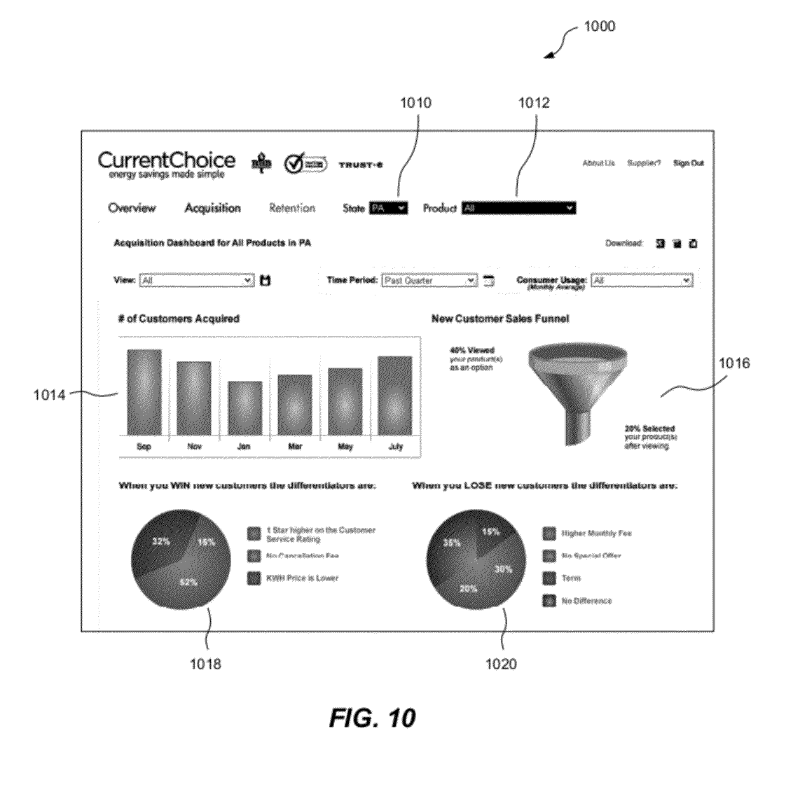

FIG. 10 shows a supplier performance page 1000. The supplier performance page may be controlled by the supplier performance module 352 and may provide suppliers with information about their performance in acquiring contracts for the supply of energy to consumers. The page 1000 may include a control, such as a drop-down list 1010, for selecting a state or other geographical region. It may also include a control, such as a drop-down list 1012, for selecting a particular product (i.e., plan), or for selecting all products. With selections made, displayed results are then limited to the selected state and product(s). Other controls may be provided to further narrow results. The page 1000 may include a region 1014 for graphically displaying a number of consumers acquired over a particular time frame for the selected state and product. In one example, this display is a bar graph. The page 1000 may also include a sales funnel region 1016 for displaying a percentage of consumers that selected the designated product(s) after viewing detailed product information (e.g., on the page 700). In addition, the page 1000 may include differentiator regions 1018 and 1020. Region 1018 may indicate differentiators among competing products and suppliers when a new consumer was won. These may include, for example, a higher supplier service rating, the absence of a cancelation fee, or a lower price of energy. Region 1020 may indicate differentiators among competing products and suppliers when new consumers were lost. Examples of these differentiators may include a higher monthly fee, absence of a special offer, a particular contract term, or no difference. Preferably, the WA 110 collects clickstream data, i.e., records of user activity, mouse clicks, and data entry on pages of the WA. The supplier performance module 352 may analyze the clickstream data collected from consumers to measure consumer activity on the WA and help determine the various product differentiators. In an embodiment, the WA provides for running market splits to help determine product performance. Varying offers can be segmented by region, contract duration, consumer profile and other variables. Results can be presented in a side by side format, or other graphical representation to demonstrate the relative performance between the market splits.

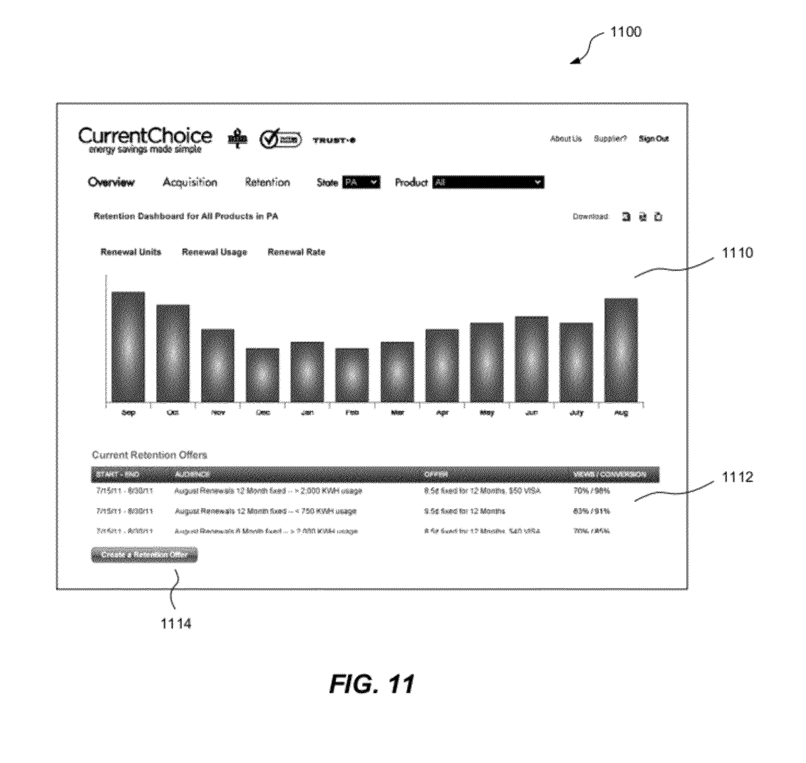

FIG. 11 shows a supplier retention page 1100. This page may be controlled by the supplier retention module 354 and provides suppliers with information about their success in retaining consumers after their contracts expire. As with the page 1000, the page 1100 includes controls for selecting a particular state and product, or for selecting all products. The page 1100 may include a display region 1110 for displaying the accounts that are coming up for renewal over a particular time span, such as one year. In one example, the display region is provided as a bar graph. The page 1100 may obtain data for populating the bar graph from the consumers database 230. For example, the consumers database 230 may include fields for each consumer recording current supplier, current plan, previous supplier, previous plan, and end date of the previous plan. The page 1100 may read these fields for all or a subset of consumers, compile statistics, and display results in the display region 1110. The page 1100 may also include a region 1112 for showing current renewal offers. These renewal offers have already been made by the supplier user. The region 1112 may list, for each retention offer shown, the period of time during which the offer is available, the audience (e.g., plans or consumer criteria to which the offer applies), the terms of the retention offer, the percentage of consumers sent the offer who also viewed the offer, and the percentage of consumers who viewed the offer that accepted it. Information about which consumers viewed the various offers may be obtained with clickstream data. There will also be a list of offers that are either Active, Pending, or Expired along with other performance statistics. The page 1100 may further include a control, such as a button 1114, which allows suppliers to create new retention offers. When a supplier clicks the button 1114, the supplier may be prompted to enter information about the offer (e.g., start date, end date, audience, and terms). The supplier retention module 416 then adds a summary of the retention offer to the region 1112 and sends an alert to consumers to which the retention offer may apply. Alerts may take the form of messages passed within the WA (e.g., “ChoiceAlerts™”). Alternatively, they may take the form of email messages sent to applicable consumers, telephone calls, text messages, or direct mail sent to consumers via a postal service. Consumers receive alerts and may respond by accepting or ignoring the retention offers. Retention offers may be based on a number of criteria particular to consumers, such as a consumer's energy usage, payment history, payment method (e.g., credit card or check), and/or credit score, for example. This information may be drawn from the consumers database 230 after having been deposited there by the data access module 332, which may have obtained the information from the consumer's utility or other billing entity. In an embodiment, the button 114 also allows suppliers to create new renewal offers to be presented on the WA. That is, a retention offer can be used to keep an at risk consumer with the supplier, a renewal offer can be used to evaluate consumers who are at the end of their contract. For example, to create a renewal offer, the supplier can evaluate the customer's contract end date, their past 12 months of energy usage, prevailing market pricing, the customer's credit profile, the customer's payment history, and the customer's payment method to create a renewal offer. The renewal offer can be communicated to the consumer (e.g., text message, email, web page). The customer can then compare the offer with the market data via the WA.

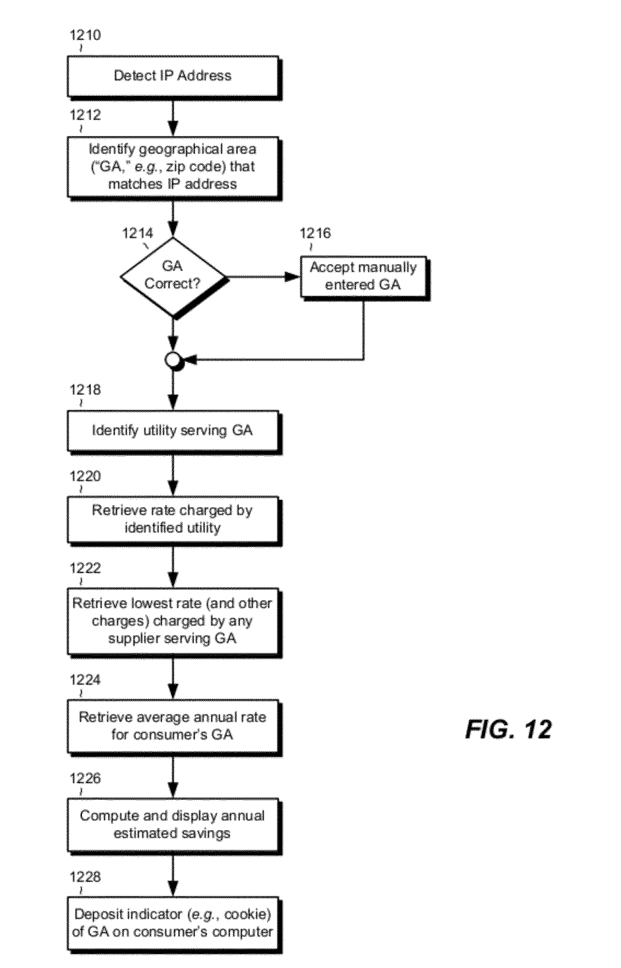

FIGS. 12-17 show some of the processes associated with the modules and web pages described above. For each of these processes, except where clear dependencies are present, the order of steps performed may be varied. Some steps may be performed in different orders from those shown, and some steps may be performed simultaneously. Terms that indicate sequences of events, such as “then” and “next” are provided to indicate the flow of events pictured in the figures; however, these terms should not be construed as requiring that steps must occur in the indicated sequences.

FIG. 12 shows an example of a process 1200 for estimating a monetary savings to a consumer by switching to a different supplier of energy. This process is controlled by the homepage savings module 312 and may operate in coordination with the web page 400 of FIG. 4. When a consumer user visits the WA 110, the WA performs an IP sniff or similar process to detect the IP address of the user's machine (step 1210). In one example, the web server 216 may obtain the visitor's IP address from HTTP headers received when the user visits the WA. The WA 110 applies the obtained IP address to identify a corresponding geographical area, such as a zip code (step 1212). Preferably, the tools database 232 includes a look-up table or other tool associating IP addresses with zip codes. Tables associating IP addresses with zip codes may also be available from public databases. The WA then displays the identified zip code in the field 410 of FIG. 4. This field may be user-updateable to cover situations where the identified zip code is inaccurate (e.g., where VPNs or proxy servers are used) or where the user is checking on rate information about another location, such as that of a second residence, home residence (when the user is traveling), or residence of a friend or relative. If the zip code is incorrect or otherwise not appropriate (decision 1214), the user may manually update the zip code (step 1216). With the correct zip code in place, the WA identifies a billing entity serving that zip code (step 1218). Preferably, the billing entity is identified by accessing a look-up table within the tools database 232 that associates zip codes with billing entities, or by accessing one or more of the public/private databases 118. Generally, only a single billing entity serves a particular geographic area, so there is a one-to-one correspondence between location and billing entity. The WA 110 may next retrieve three quantities:
1) the default power rate of the identified billing entity (step 1220). This is a rate that the utility or other billing entity charges by default to consumers who have not selected alternative suppliers. This information may be stored and accessed from the suppliers' database 234 (as the utility or other billing entity acts as a supplier in this capacity);
2) the lowest energy rate available in the consumer's zip code (step 1222). The WA preferably determines this rate by accessing the suppliers' database 234 and identifying the least expensive 12-month fixed price energy plan provided by any supplier serving the displayed zip code. Other length contracts and/or variable rate contracts may alternatively be selected. Supplier rate information may be obtained by the WA using the supplier access module 256, which may use XML feeds, direct data entry, or other data feeds to exchange data with different suppliers for accessing rate information on a regular basis, such as daily; and
3) the average monthly or annual energy consumption for residences in the displayed zip code or state in which the zip code is found (step 1224). This value may be determined by accessing data from one or more of the public/private databases 118, such as the EIA.

Given these three quantities, the WA may calculate the estimated monthly or annual savings for an average residence within the displayed zip code that could be obtained by switching to the lowest priced available 12-month fixed rate product (step 1226). The software may display this estimated savings, for example, in the field 412 of the page 400.

The typical user experience is thus to navigate to the site's homepage, whereupon the WA 110 automatically displays the user's zip code and the estimated dollar or percent savings that could be obtained by switching to the least expensive 12-month power contract offered by any supplier of electric power serving the users utility or geographic area.

The WA 110 may deposit an indicator, such as a cookie, on the consumer user's machine (step 1228). The cookie preferably stores the user's zip code. The next time the user visits the WA, the WA may retrieve the cookie and display the correct zip code on the page 400.

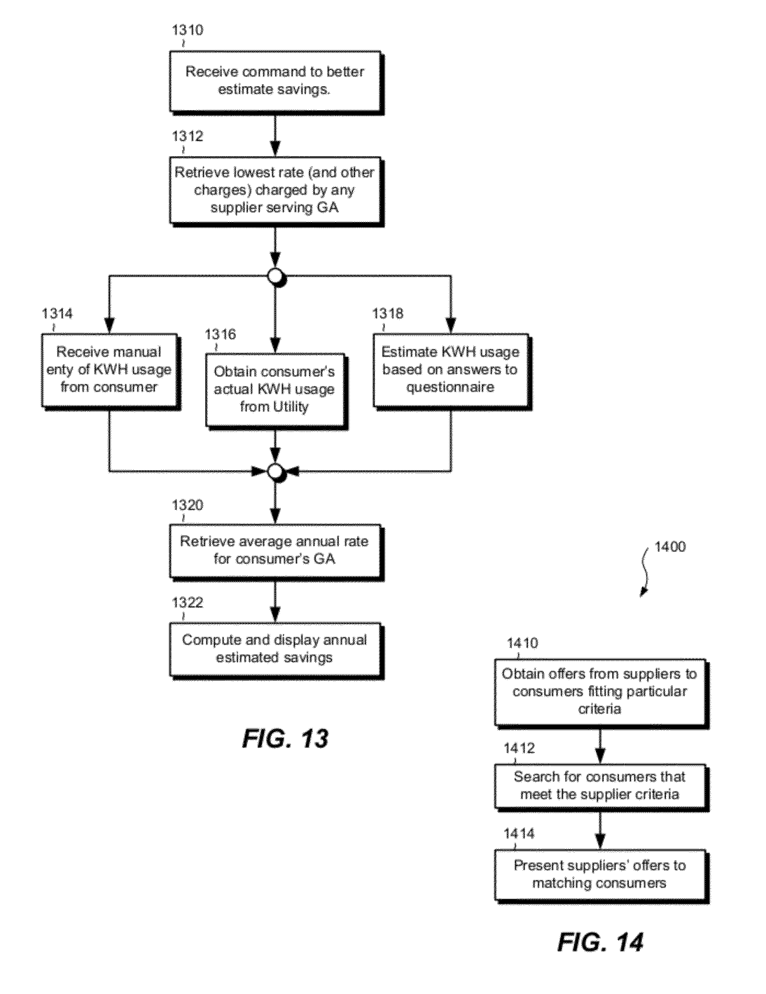

FIG. 13 shows an example of a process 1300 for creating improved estimates of a consumer user's savings. The estimates produced by this process are generally better than those computed in connection with FIG. 12, as they are based on actual usage data or informed estimates of energy usage, rather than on averages for the user's area. The process of FIG. 13 is controlled by the estimated savings module 314 in coordination with the web page 500. The process may begin with a command from the consumer user to better estimate savings (step 1310). For example, the user may click the button 516. In response to this command, the WA 110 may retrieve the lowest 12-month fixed contract rate offered by any supplier in the consumer user's geographical area (e.g., zip code). Other contract terms or types (e.g., 6-month or variable term) may alternatively be used. Information about supplier rates may be obtained the same way as in step 1222 above. The WA may next prompt the user to provide information to inform the WA of the user's energy consumption. This may generally be done in one of three ways:
1) The WA may prompt the user to enter an actual KWH usage for the property (step 1322). The user may obtain this information from the user's power bill;
2) the WA may obtain the user's actual KWH usage from the user's utility or other billing entity (step 1324). For example, the WA may employ the data access module 332 to log onto the billing entity's web site and obtain the information about the consumer's usage directly;
3) the WA may present the user with questions relevant to the user's energy usage, such as square footage of the user's property, the year the property was built, and the type of insulation used. The WA may also check one or more public/private databases 118 for information about the property, or about other properties in the user's area. This information may be combined with the user's responses to the questions and processed to ascertain an informed estimate of energy usage.

At step 1328, an average annual energy rate is retrieved for properties in the user's geographical area (e.g., zip code). This rate may be determined based on inputs from one or more of the public/private databases 118.

At step 1330, the WA computes and displays the annual or monthly estimated savings. This computation may simply be the difference between the average rate of step 1328 and the lowest rate of step 1312, times the estimated or actual energy usage determined in any of steps 1322, 1324, and 1326. The annual or monthly savings indicator 412 on page 400 may then be updated with the newly computed estimated savings.

In addition, the WA may compute updated savings estimates for each of the energy plans displayed in the region 510 of page 500. Instead of using an average rate for step 1328, the WA may instead use the actual contract rate for the respective energy plan. Computation of estimated savings may proceed as before, and the results may be displayed in the region 510 of the page 500.

FIG. 14 shows an example of a process 1400 for presenting offers from suppliers of energy to consumers based on consumer criteria. At step 1410, the WA 110 obtains an offer from a supplier for providing energy to consumers that meet certain criteria. For example, suppliers may offer cheaper rates to consumers who have higher than normal energy usage, or that have a record of on-time payment, or that pay using check versus credit card, or vice versa. The offer may be a retention offer as described in connection with the supplier retention page 1100. At step 1412, the WA identifies consumers that meet the supplier criteria. This may be done, for example, by querying the consumers database 230 and filtering results based on the supplier criteria. At step 1414, any consumers that match the supplier criteria may be contacted and extended the special offer. Retention offers made using this process may be listed in the region 1112 of the supplier retention page 1100. This process may also be used to extend offers to new consumers, i.e., those who are not already customers of the supplier making the offer.

Alternatively, the WA may gather consumer data for consumers and send them to a supplier, such as using an XML feed or other data link to the supplier's computer system. The supplier may identify contract terms the supplier is willing to offer each of the consumers based on their respective consumer data. The supplier may then send offers back to the WA, which the WA may forward to the respective consumers.

Tailored supplier offers may also be extended on an individual basis to consumers. For example, when a consumer user logs on to the WA and the user's consumer data is obtained, the WA may determine a rate to apply to the consumer based on the consumer data of the consumer and a set of rules previously provided by the supplier. Alternatively, the WA may send the consumer data to the supplier, and the supplier may identify contract terms that apply to the consumer and send those terms back to the WA, where they may be communicated to the consumer.

In operation, in an embodiment, the consumer can provide their authorization via the WA to access their energy usage characteristics from a variety of sources. (e.g., KWH usage, credit profile, size of home, age of home, number of occupants, region, etc.). The WA then determines which offers that suppliers are willing to make based on the consumer's characteristics. The WA facilitates the creation, dissemination and the appropriate offers for the consumers and the suppliers. The offers can be presented to the consumer and their acceptance or rejection of an offer can be captured and stored. In general, the WA can provide near real-time point-of-sale pricing based on customer characteristics.

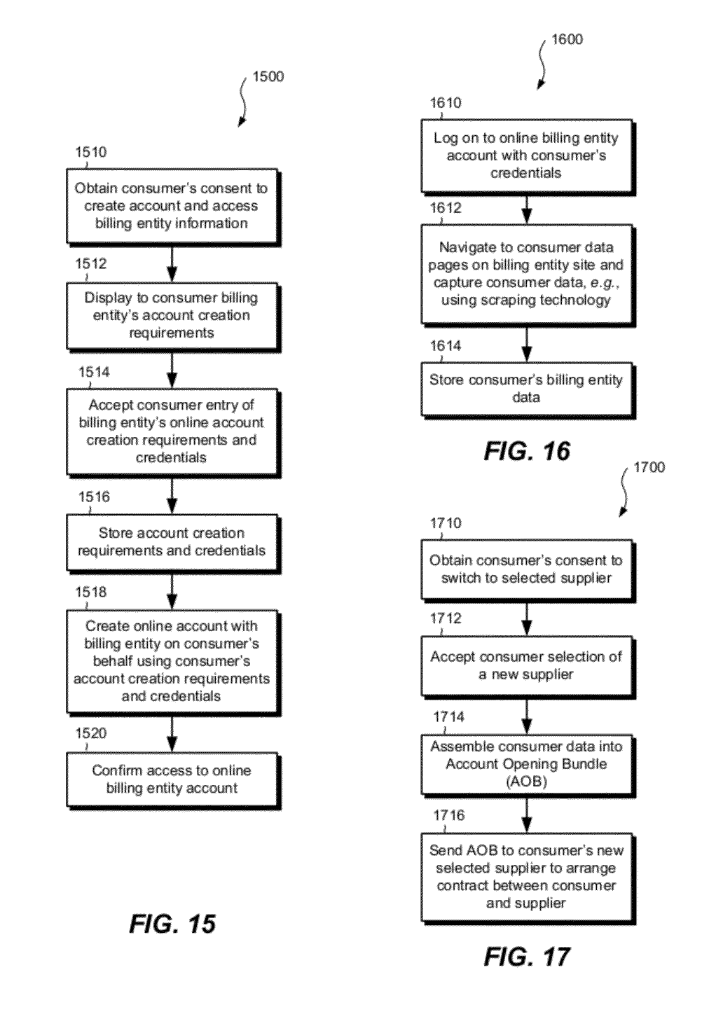

FIG. 15 shows an example of a process 1500 used by the WA 110 to create an account for a consumer on the website of the consumer's utility or other billing entity. This process may be controlled by the billing entity account create module 330 in coordination with the page 800. It is assumed that the identity of the consumer's billing entity is already stored in the WA when this process is begun. If not, the process may begin by identifying the consumer's billing entity using techniques already described. At step 1510, the WA 110 may obtain the consumer's consent to create an account for the consumer on the billing entity's website and to access the consumer's information at the billing entity. As already indicated, billing entities have their own web applications on which consumers may create accounts to view their consumer data, pay their bills, and perform other functions. The WA 110 displays requirements for creating this account at step 1512. These requirements may be in the form of fields on the page 800, and may include the consumer's billing entity account number. There may be other requirements, depending on the particularities of the billing entity's website. In one example, the page 800 may be created dynamically and made to include all fields that are required by the particular billing entity. In most cases, there is no need to display fields for receiving customary information, such as the consumer's name, contact information, username, password, challenge question, and challenge response. These may be omitted from the displayed fields, as the WA may use input already received for creating an account on the WA itself (e.g., via page 700) to populate the corresponding fields on the billing entity's website.

Some billing entities employ CAPTCHAs, i.e., Completely Automated Public Turing tests to tell Computers and Humans Apart, to prevent automated access to their sites via bots and other automated programs. When a billing entity's site restricts user registration using a CAPTCHA, the step 1312 may include graphically capturing the CAPTCHA from the billing entity's site and providing the captured version of the CAPTCHA to the page 800 for display to the consumer user. The consumer user of the WA 110 may then be prompted to enter the requested text into the reproduced CAPTCHA fields.

At step 1514, the WA 110 accepts information from the consumer for creating the account at the billing entity. This step may be performed when the user clicks the button 816 on page 800. Any entered account information may then be stored by the WA (step 1516) and applied (step 1518) to create the account for the consumer on the billing entity's website. Any text entered in a CAPTCHA may be passed back to the appropriate fields on the billing entity's site, to allow registration to proceed. Access to the consumer's account at the billing entity may then be confirmed (step 1520) by the WA attempting to log on to the consumer's account using the credentials supplied. The resulting account may be used by the WA 110 to retrieve consumer data about the consumer on a regular basis and/or in response to various events.

FIG. 16 shows an example of a process 1600 used by the WA 110 for obtaining consumer data about consumers from their respective billing entities. This process may be controlled by the data access module 332 and may use accounts created at billing entities using the process of FIG. 15. It may preferably be conducted for one consumer at a time. At step 1610, the WA logs onto a consumer's account at the consumer's billing entity using the credentials previously supplied. Once logged on, the WA may obtain consumer data pertaining to the consumer from the billing entity's site (step 1612). The WA may navigate to different pages of the billing entity site and selectively acquire consumer data from those pages. The consumer data may include, for example, a consumer's bills, energy cost, energy usage, designated supplier of energy, last meter read date, and payment history and methods.

Preferably, consumer data is extracted by scraping. The WA may read the pages of the billing entity site, automatically identify consumer data within the pages, and store the consumer data with the WA, such as in the consumer database 230. Scraping software may be written into the data access module 332 or provided by a third party that specializes in this technology. For example, scraping a web page can include parsing the HTML and extracting relevant data. As an alternative to scraping, pages may be inspected manually, by human operators, who may identify consumer data on the billing entity site and copy it back to the WA 110. In an embodiment, the consumer data can be provided based on a stored procedure or other API. Data transfer via web services, SOAP exchange, or file transfer can also be used.

FIG. 17 shows an example of a process 1700 for engaging a consumer in a contract with a supplier for the supply of energy. This process may be controlled by the supplier select module 320 in coordination with the billing entity account creation page 800. At step 1710, the WA may obtain a consumer's consent to switch to the selected supplier. For example, the page 800 may respond to the checkbox 812 being clicked. At step 1712, the WA 110 may accept a selection by a consumer of a new supplier. For example, the page 800 may respond to the button 816 being clicked. At step 1714, the WA may assemble an account opening bundle (AOB). The AOB may include, for example, the consumer's billing entity account number, next meter read date, name, physical address, mailing address, product purchased, and contract (generally a PDF) electronically signed by the consumer for acquiring energy from the supplier under the contract's terms. The WA may gather this information from consumer data entry on the pages 700 and 800, as well as from the consumer data retrieved from the user's billing entity. At step 1716, the WA may send the AOB to the selected supplier to put the signed contract with the supplier into effect. Preferably, the supplier access module 356 sends the AOB to the supplier electronically, such as via an XML feed or other electronic transfer to a computer system of the selected supplier.

The process of FIG. 17 provides many conveniences to both the consumer and the supplier. Once the consumer sets up an account with the WA 110, it may switch or renew a supplier with little or no additional data entry, as all the information needed to assemble the AOB may already be stored in the consumers database 230. Both the initial sign-up process with a supplier and any subsequent sign-up processes are made simple by the consumer's use of the WA. Suppliers may also benefit, as data entry on their side is reduced, as well. Also, since the WA typically obtains all the billing entity information needed to effect the switch to a new supplier, the supplier's need to coordinate with the billing entity may be reduced or eliminated.

The WA 110 therefore provides a mechanism through which consumers of electricity may easily access the critical information they need to make informed decisions and confidently participate in the competitive energy market. The WA 110 is expected to lower barriers to participation of consumers in this market as it lowers their energy costs and simplifies the process of switching suppliers.

As used throughout this document, the words “comprising,” “including,” “having,” and the like are intended to set forth certain items, steps, elements, or aspects of something in an open-ended fashion. Also, as used herein, the phrase “based on” does not necessarily mean based exclusively on. A thing that is “based on” one thing may be based solely on that thing or may be based on that thing and based on other things, as well. A “quote” as used herein is an offer to sell energy under particular terms. Quotes can be tailored to particular consumers or may reflect standard terms applicable to all consumers.

Various aspects of the inventions may be used alone, in combination, or in a variety of arrangements not specifically discussed in the embodiments described in the foregoing. Therefore, the invention is not limited in its application to the details and arrangements of components set forth in the foregoing description or illustrated in the drawings. For example, aspects described in one embodiment may be combined in any manner with aspects described in other embodiments.

The invention hereof may be provided in the form of a non-transitory computer-readable storage medium having computer-executable instructions which, when executed, carry out a method. The non-transitory computer readable storage medium may take any suitable form. Non-limiting examples may include one or more magnetic discs or tapes, one or more optical media such as compact discs or DVDs, or one or more solid state media such as flash drives.

Having described certain embodiments hereof, numerous alternative embodiments or variations can be made. For example, the structures and processes disclosed herein may be applied to obtain goods or services besides electric power. These include other forms of energy, such as natural gas, propane, and heating oil. They may also be applied in other markets besides energy, such as telephone service, cell phone service, cable television, Internet, mortgages, and credit cards.

Also, the WA may aggregate billing and usage information for multiple campus/branch and multiple building commercial enterprises to facilitate the procurement of commercial energy contracts. For example, energy brokers or other parties may seek to obtain tailored energy rates for multiple properties under a common set of contract terms. Ordinarily, the brokers would be required to obtain consumer data on each of the properties separately, including communicating with each property's billing entity and obtaining energy usage and/or payment history. According to one variant, the WA may provide an interface for brokers, which allows them to aggregate different properties into a group and obtain supplier quotes for the group of properties as a whole. Consumer data may be obtained for each property separately (as is normally done for consumers). The WA may aggregate the consumer data for the different properties to create aggregate AOB's. The WA may then send the aggregate AOB's to the selected suppliers for quoting. The ability of the WA automatically to collect and aggregate data on multiple properties may save brokers a great deal of time and avoid costly data entry errors that may arise due to human error.

The WA 110 may be expanded to allow control and monitoring of energy used by consumers. For example, the WA may communicate with IP addressable smart meters, sub-meters, appliances, machinery, and HVAC systems. Additional energy saving may be obtained through any of the following:
1) alerts on time of day electricity pricing to allow heaviest usage when rates are lowest;
2) use of comprehensive energy monitoring tools that can automatically regulate (turn on and off) appliances; machinery and HVAC units for maximum energy efficiency and cost reduction;
3) real time feedback to consumers on the energy consumption of appliances, machinery and HVAC systems; and
4) recommendations for the maintenance, repair and/or replacement of appliances, machinery and HVAC systems to improve energy efficiency and saving, including specific recommendations on the type and model needed for replacement, where it can be purchased or ordered on-line, and links provided to arrange for installations.

It is understood that not all of the software modules shown in FIG. 3 need to be included in all embodiments, and that certain embodiments may include additional software modules. For example, additional supplier modules 224 may be provided, such as a cancelation manager module and an at risk manager module.

The cancelation manager module may provide the supplier with a notification (e.g., an “814”) that a consumer is no longer obtaining power from the supplier and has switched back to the consumer's utility (default power). Once the supplier receives this notification, the supplier may have an opportunity to create a “rescue offer” with the WA 110, i.e., an offer directed to the consumer that attempts to win back the consumer's business. Some cancelations can be due to the consumer's change of address (i.e. moving to a new home or business address). In such a circumstance, the supplier can receive the new address via the WA and create a custom offer for the customer based on the new address.

The at risk manager module may provide suppliers with information about customers who are at risk of changing suppliers. The at risk manager module may consider a variety of factors. For example, it may identify consumers who have recently been back to the WA 110 shopping for power. It may identify consumers who have low or no cancelation fees, or who are paying rates above currently available rates. It may consider whether the consumer's contract is fixed or variable. The at risk manager module may gather this information, identify consumers whose contracts and/or behavior indicate that they may be at risk of attrition, and inform suppliers of their at risk consumers, so the suppliers have an opportunity to modify contracts or otherwise prevent attrition. In one example, the supplier may create a blend-and-extend offer in an attempt to retain the consumer's business.

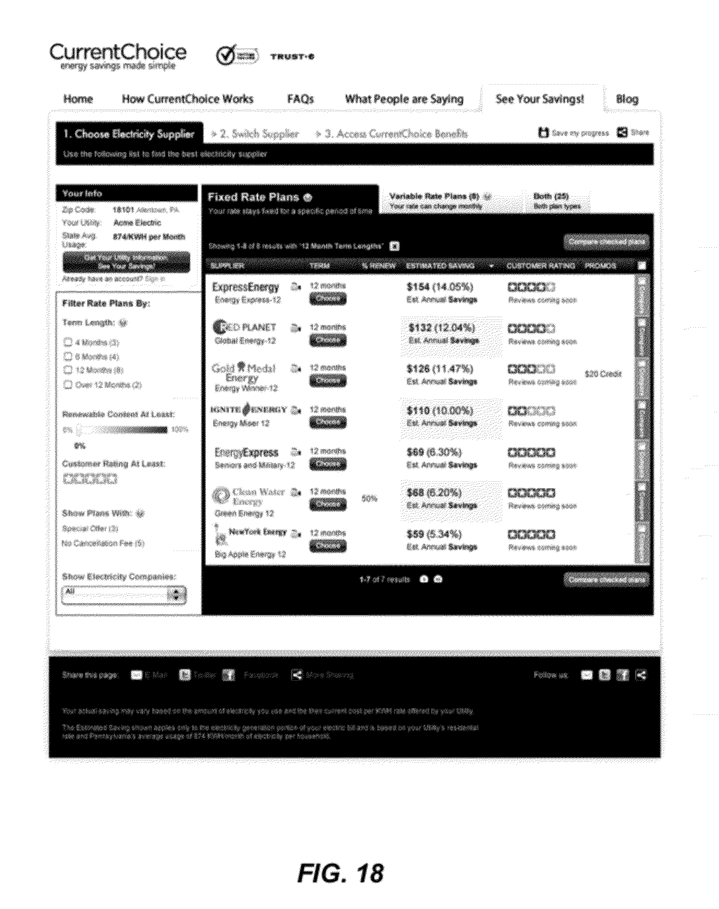

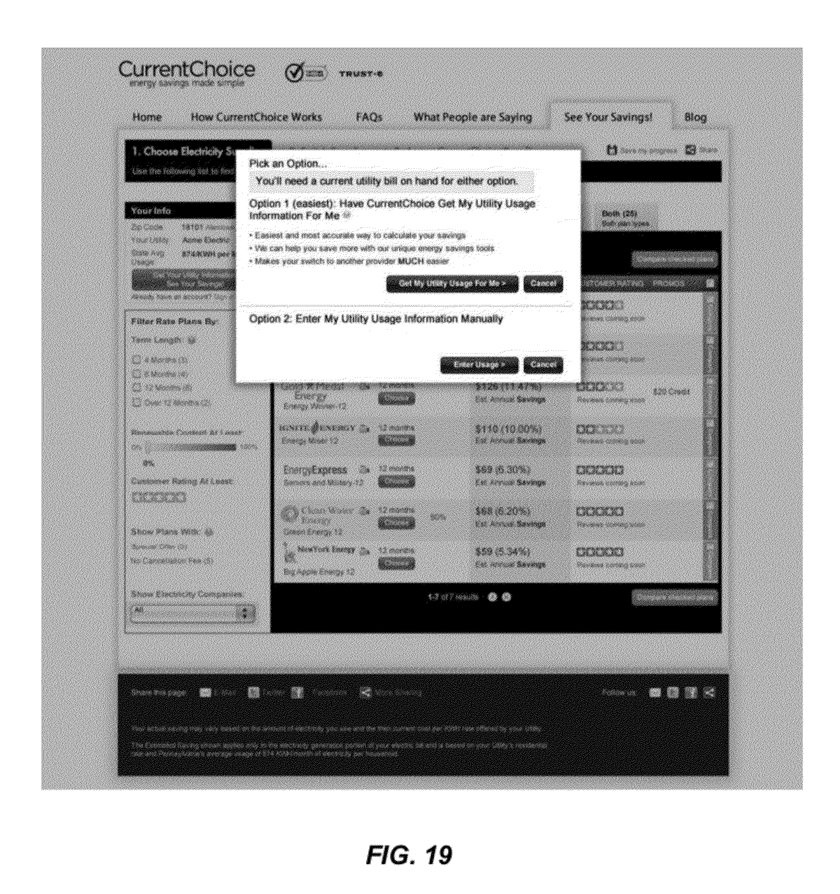

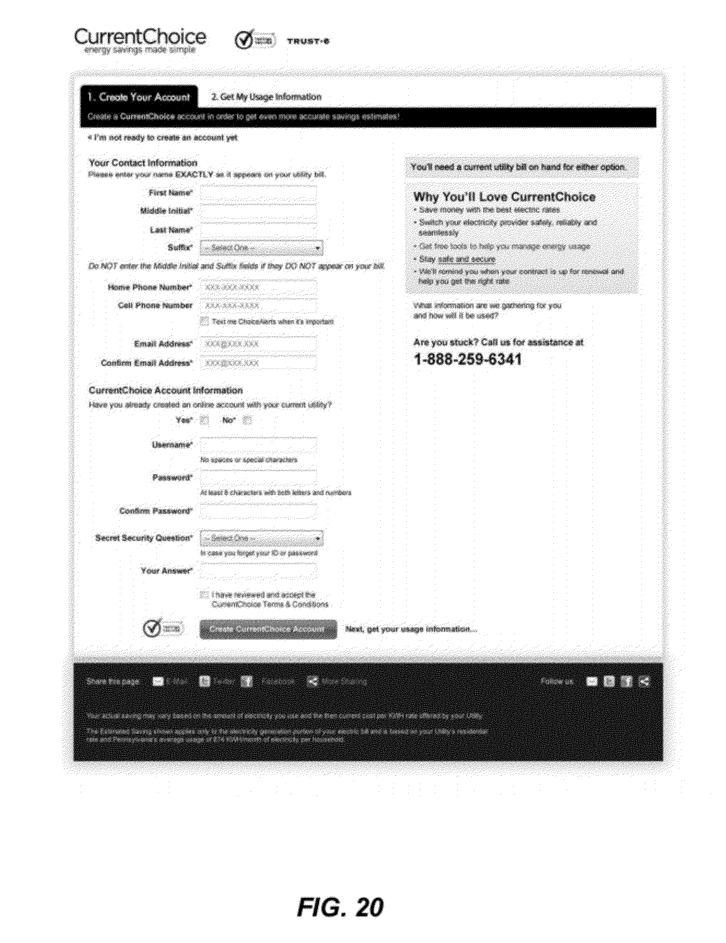

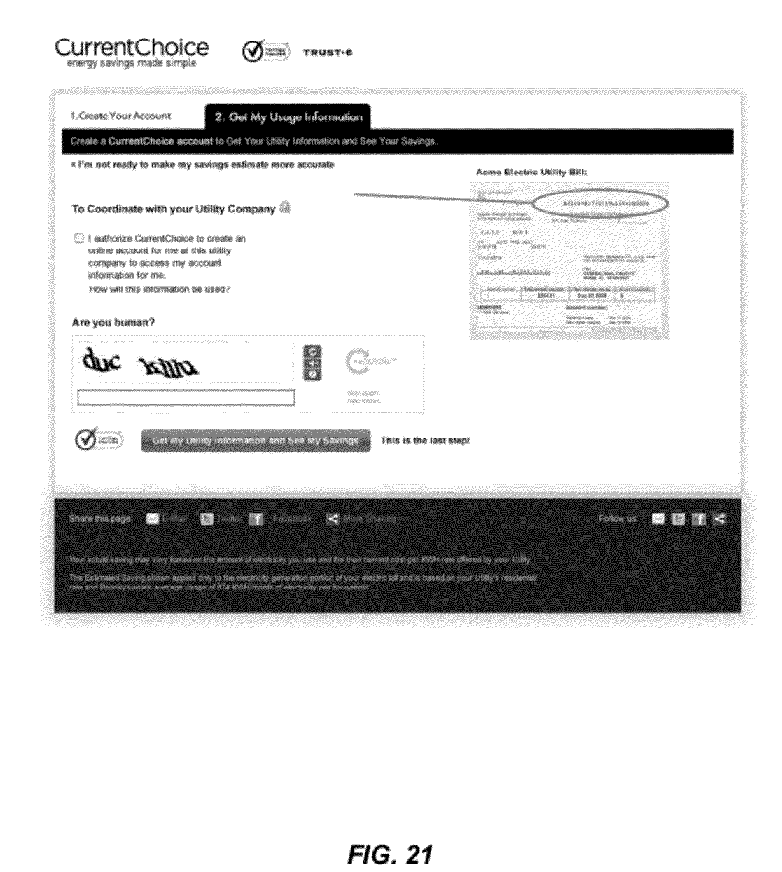

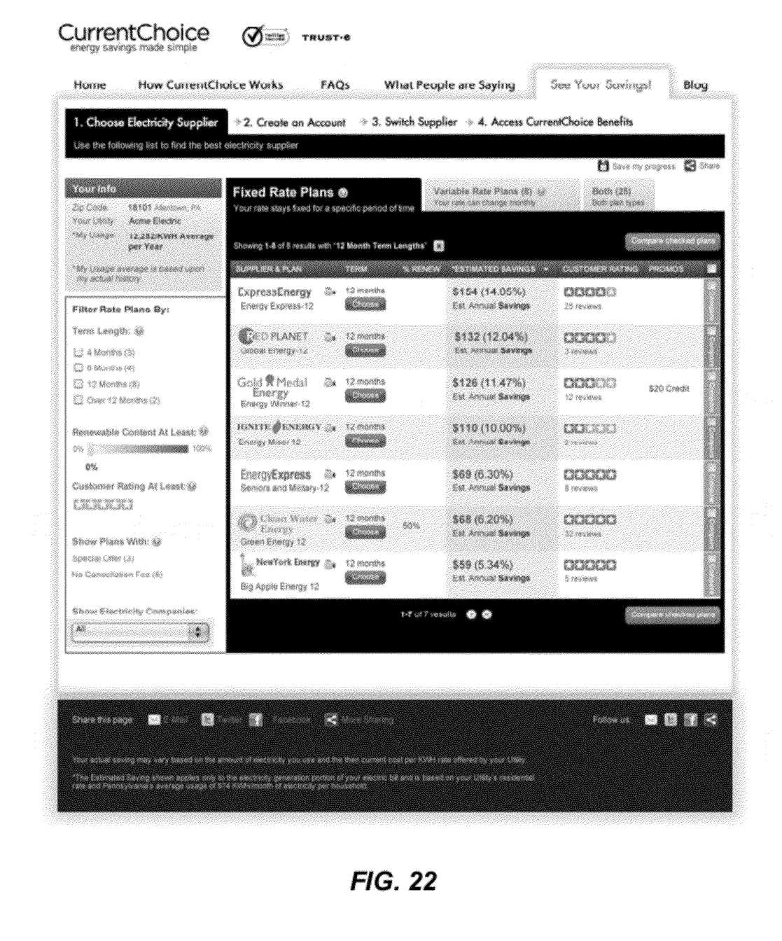

New FIGS. 18-31 are included in a separate file herewith to show alternative implementations of some of the web pages of the WA 110. FIG. 18 is a variant on FIG. 5 and includes a button, “Get your utility information. See your savings!” A consumer user who clicks that button may be prompted to choose between entering energy usage manually and having the WA 110 obtain the information automatically (See FIG. 19). Those choosing the automatic route may be prompted to enter account information for creating an account on the WA 110 and on the billing entity's website. See FIGS. 20 and 21, which are variants of FIGS. 7 and 8, respectively. Once the account information is supplied, the WA 110 may connect to the consumer's billing entity and download consumer data, including usage information. The web page shown in FIG. 22 may then be displayed. This is the same as the page shown in FIG. 18, but updated to show the actual usage (see green box). Prices displayed for the various contracts (products) may reflect this actual usage, because suppliers' rates may vary based on energy usage. If, at FIG. 19, the user had selected to manually enter usage information, then FIG. 22 would still be displayed, but would reflect that the consumer's usage was manually entered.

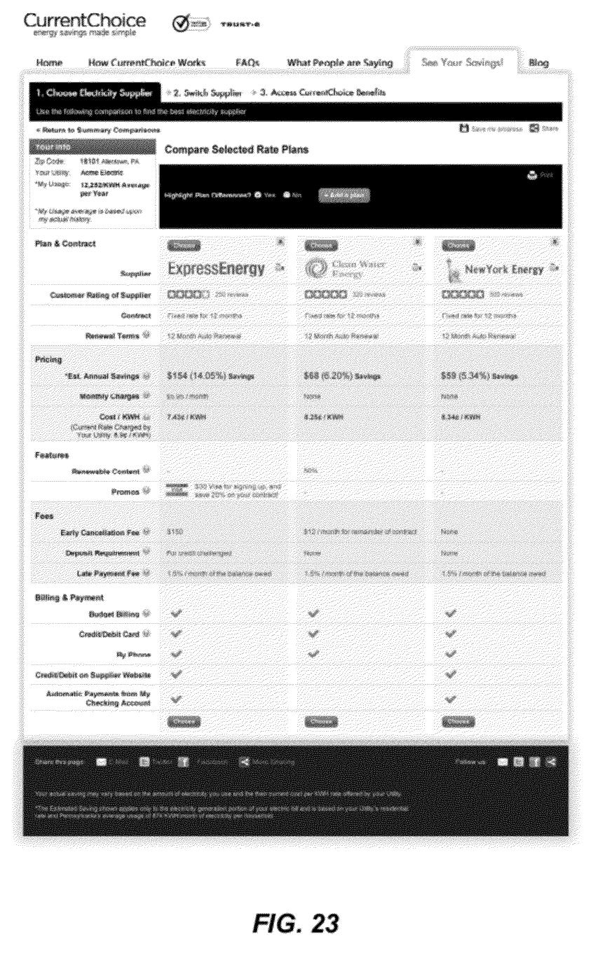

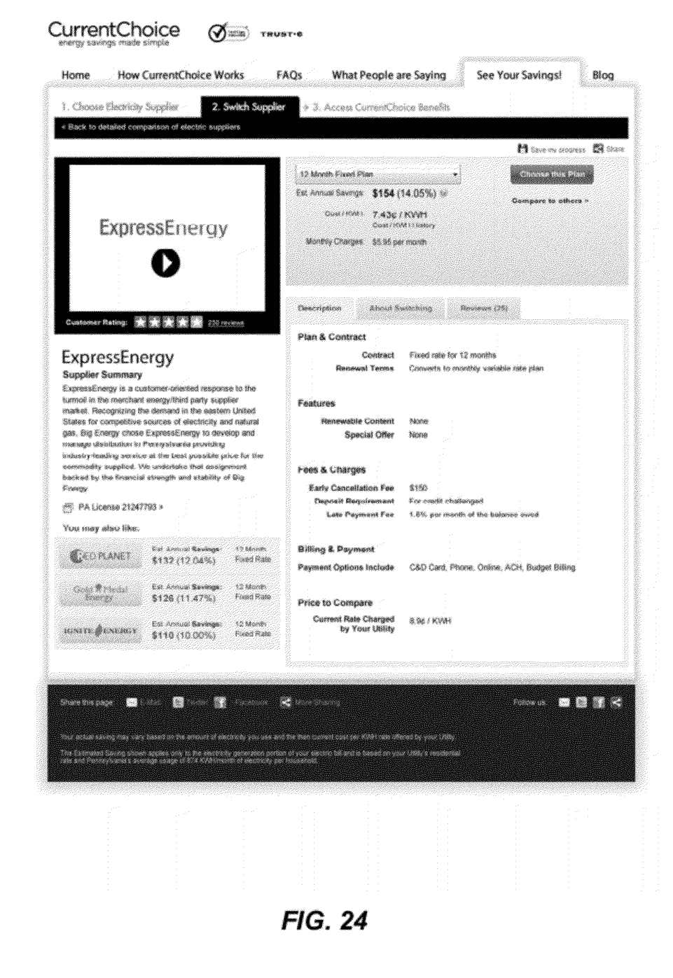

FIG. 23 shows comparison information for different supplier contracts, and FIG. 24 shows detailed information about a particular supplier contract. FIG. 24 is a variant of FIG. 6. Notably, it may include a video that describes the particular supplier contract.

When the consumer user selects the plan shown in FIG. 23 (by clicking the button “Choose this plan”), the switch to the new supplier may be made promptly, since an account generally will already have been created on the WA 110 and consumer data will generally already have been acquired from the billing entity (via the pages at FIGS. 20 and 21).

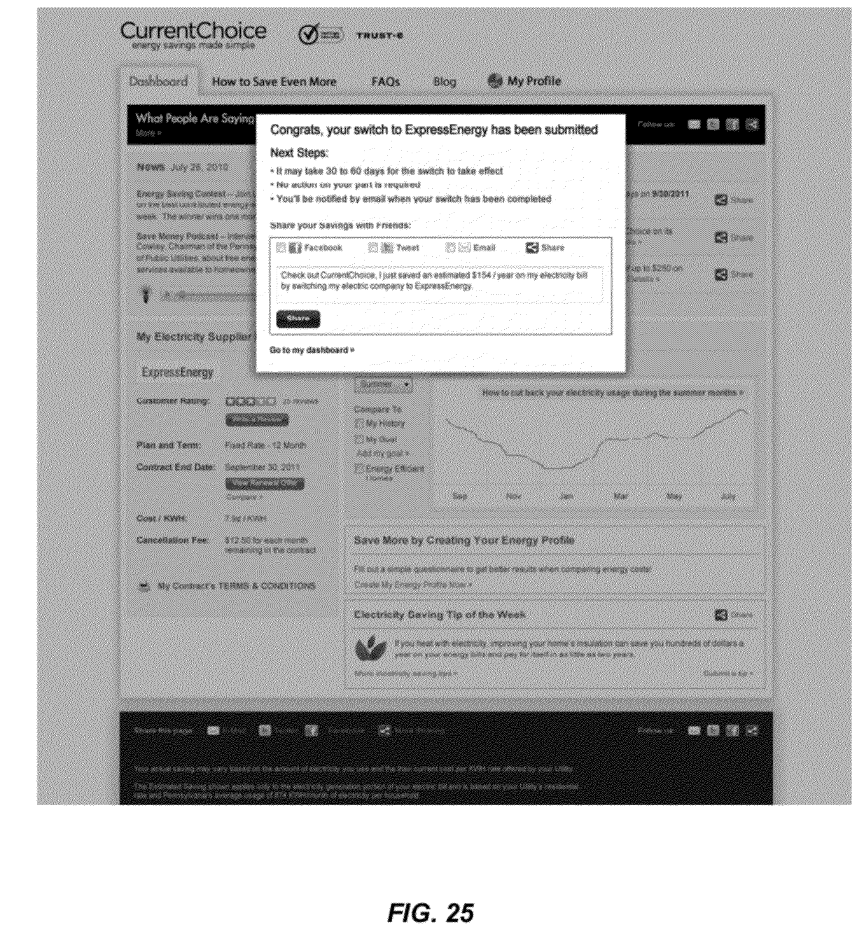

Once the consumer has effected a switch to a new contract, a page as shown in FIG. 25 may be presented, asking the user to share his impressions.

The order of operating the WA 110 via the pages of FIGS. 18-23 is thus different from that described in connection with FIGS. 5-8. The order may be varied in numerous additional ways, consistent with the invention.

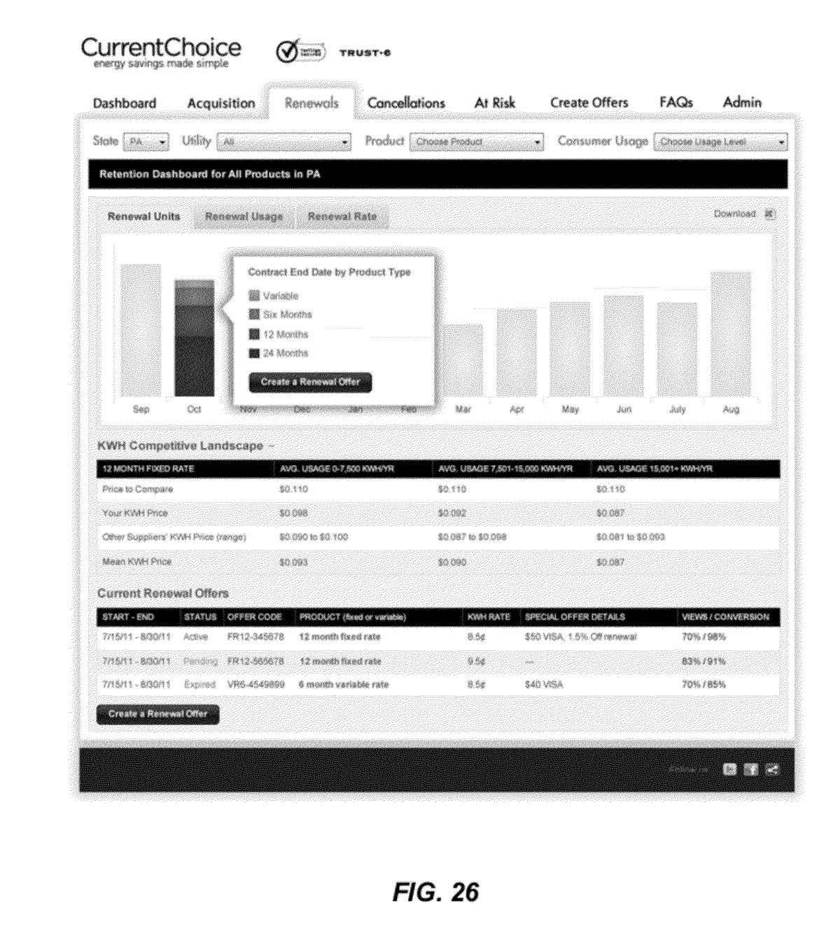

FIGS. 26-29 show variants on the supplier pages of FIGS. 10 and 11. These pages may support different types of users, such as ordinary users and administrative users. Via these pages, different information may be presented to different types of supplier users, and different information may be available to different types of supplier users.

FIG. 26 shows a renewal page. This page may allow suppliers to view how their contracts compare with those of other suppliers. It may also provide feedback to let suppliers know what products, not limited to their own, are being sold to consumers. Suppliers may click a button to create a renewal offer. A data entry sheet (not shown) may be presented to capture the terms of the offer. The created offer may be stored in the suppliers database 234 and made available to applicable consumers, such as via the pages shown in FIGS. 22-24. In one example, an offer may be set up by one user at the supplier but then approved by another user with higher privileges.

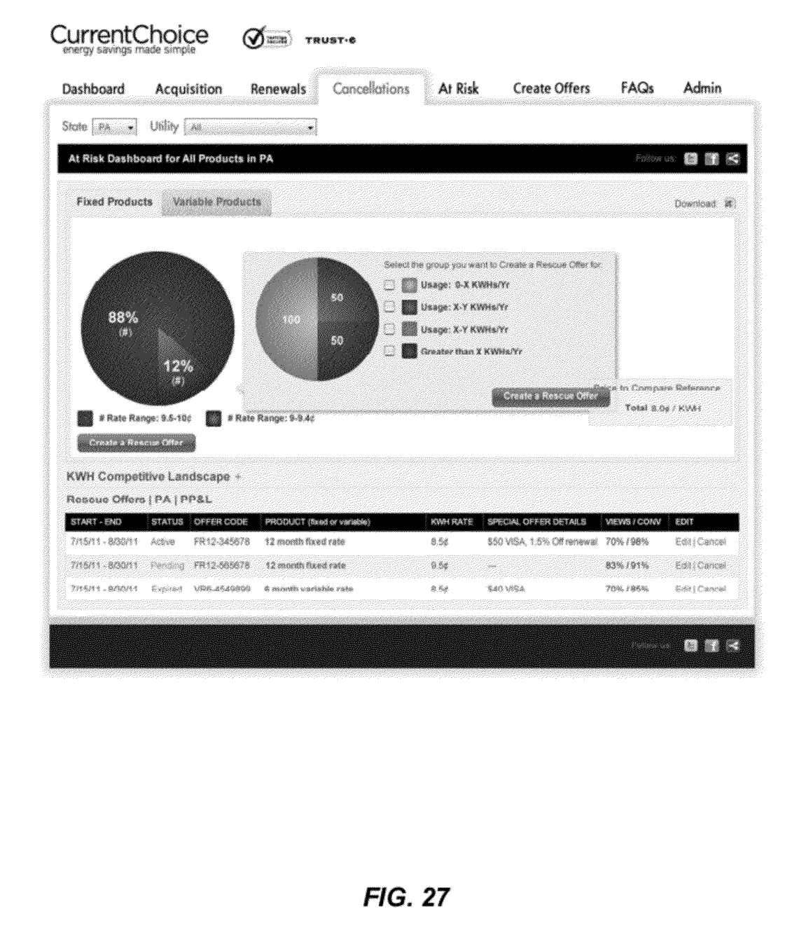

FIG. 27 shows a cancelation page, which may be controlled by the cancellation manager module. This page allows a supplier to create a rescue offer to recapture the business of a consumer who has recently switched back to its default supplier of power (generally, the utility).

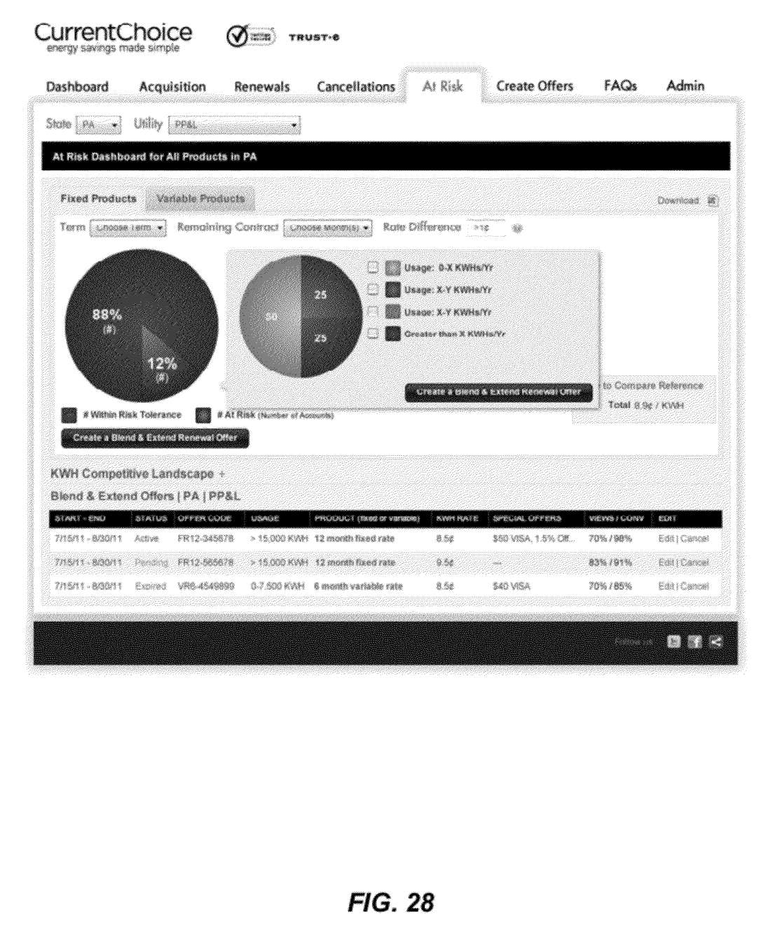

FIG. 28 shows an at risk page, which may be controlled by the at risk manager. This page allows a supplier to identify consumers who are at risk of attrition, and to create blend-and-extend offers in an effort to retain the consumers' business. The terms of the blend-and-extend offers may be included in the supplier database 234 and made available to applicable consumers.

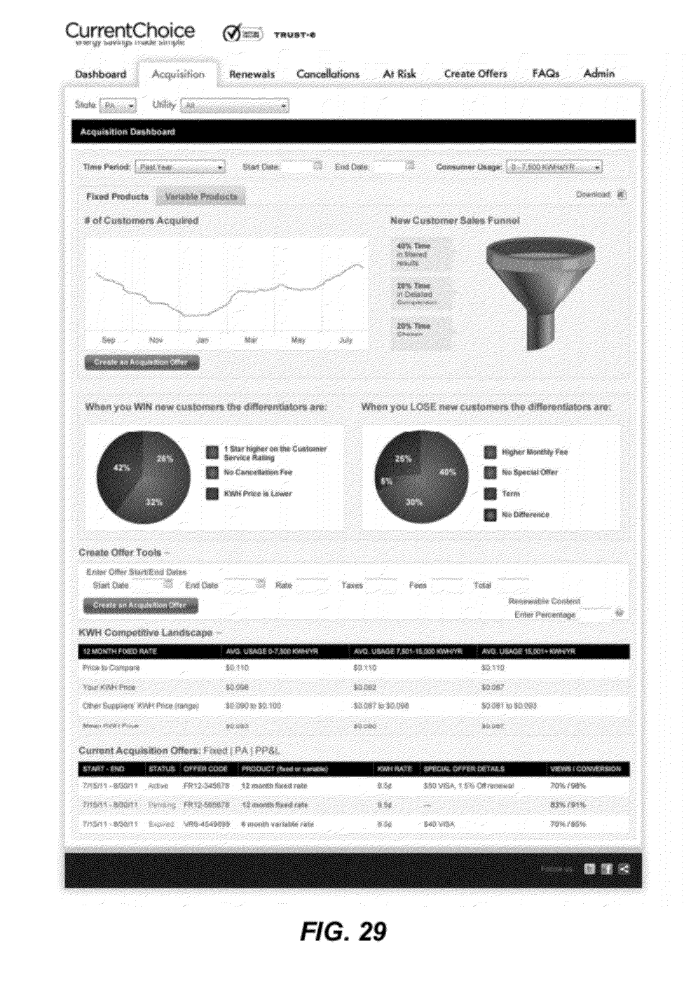

FIG. 29 shows a supplier acquisition page. This page is a variant of the page 1000 shown in FIG. 10 and may include supplier tools for creating acquisition offers to consumers and viewing competitive offers from other suppliers.

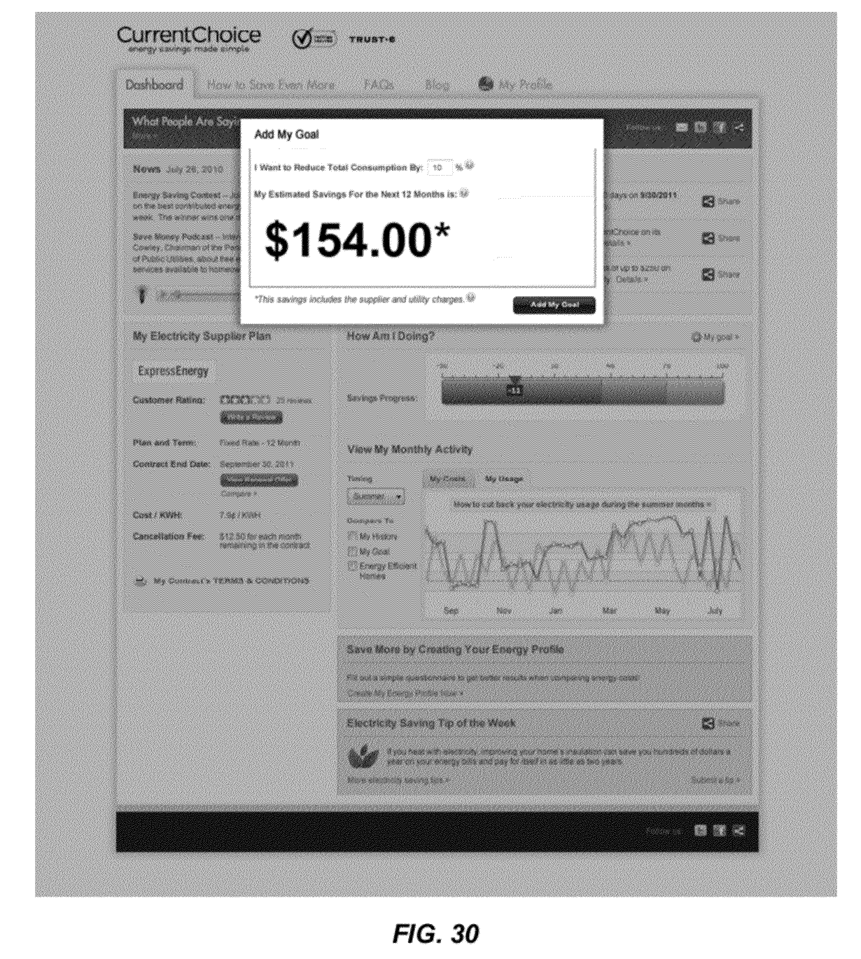

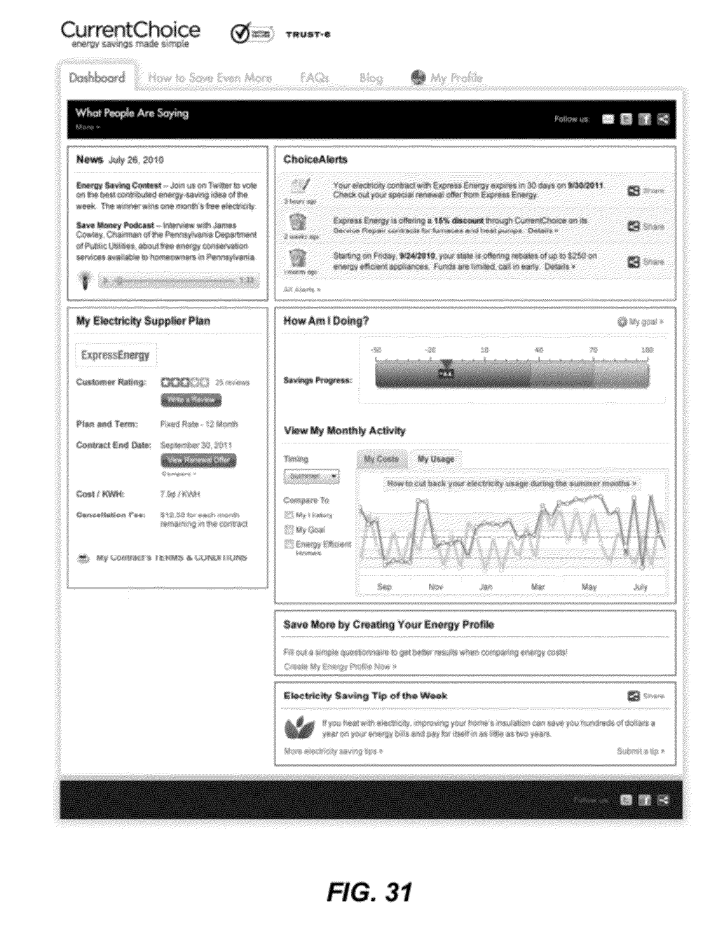

FIGS. 30 and 31 show a consumer dashboard page, which is a variant of FIG. 9. Here, consumers may enter desired energy savings goals and view their progress on horizontal bars.

The variants shown in FIGS. 18-31 are just some of many ways in which different web pages may be provided consistent with the invention.

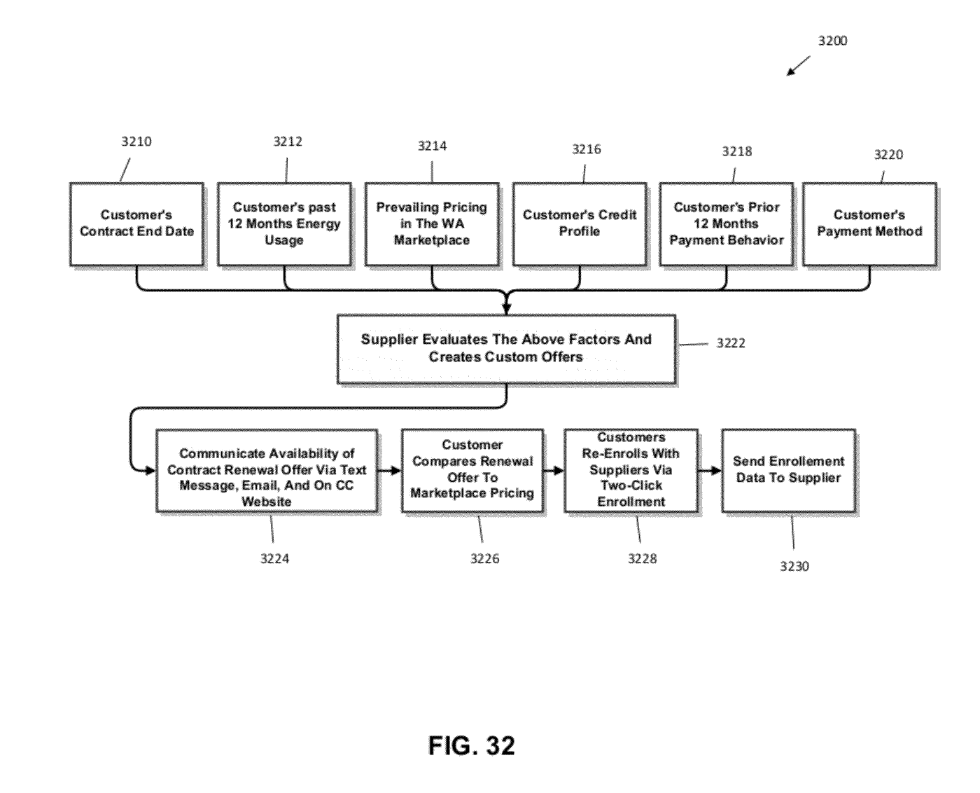

Referring to FIG. 32, with further reference to FIG. 3 and FIG. 26, a block diagram 3200 of a contract renewal manger code segment is shown. In an embodiment, the contract renewal code segment can be part of the supplier retention module 354. The contract renewal program segment can gather information from a variety of sources about the customer. In an embodiment, information (e.g., characteristics, factors) can be scraped from the data storage at a utility and other third party databases. As an example, and not a limitation, information such as the customer's contract end date 3210, the customer's past 12 month energy usage data 3212, the customer's payment method 3220, and the customer's payment history 3218 can be scraped. Other customer specific information may also be available such as the customer's meter read date, the customer's current energy supplier, and the current rate the customer is being charged. Other information may also be available that is relevant to determining the profitability of a customer. For example, the consumer's credit profile 3216 and prevailing energy prices 3214 can be obtained from one or more third party databases. In an embodiment, with further reference to FIG. 29, the prevailing energy prices include the offers entered into the WA by other suppliers. The methods of connecting to, and retrieving data from, these databases can vary based on security requirements and other proprietary algorithms used to access and exchange data (e.g., scraping, stored procedures, Web services, SOAP). In an example, as discussed above, personal data can be obtained by creating a user account on behalf of the user. This new user account can be established and configured in the renewal manager code segment. That is, the renewal manager code segment can receive personal information from the user (e.g., name, current address, future address, email address, user id, password) and then subsequently utilize that personal information to create a user account within one or more utilities websites automatically. Once the account is created, the system can log into the account and obtain the required user data. For example, the system can read the HTML tags in the user account webpage. The data acquisition is not limited to the time of the account creation. Rather, the system can be configured to scrape the customer's data on a periodic basis (e.g., daily, weekly, monthly).

In an embodiment, a supplier can evaluate the customer factors individually or in aggregate to create custom offers 3222. The contract renewal code segment can utilize the features of the WA to communicate the terms of the renewal contract to the customer 3224 (e.g., via text message, email, webpage). At stage 3226, with further reference to FIG. 23, in an embodiment the customer can compare the renewal offer to other offers in the marketplace. At stage 3228, with further reference to FIG. 24, the customer can elect to accept the renewal offer via clicking on object on the user interface (i.e., a contractual relationship can be created with the customer's authorization). At stage 3230, with further reference to FIG. 26, the enrollment data is provided to the supplier for activation and analysis.

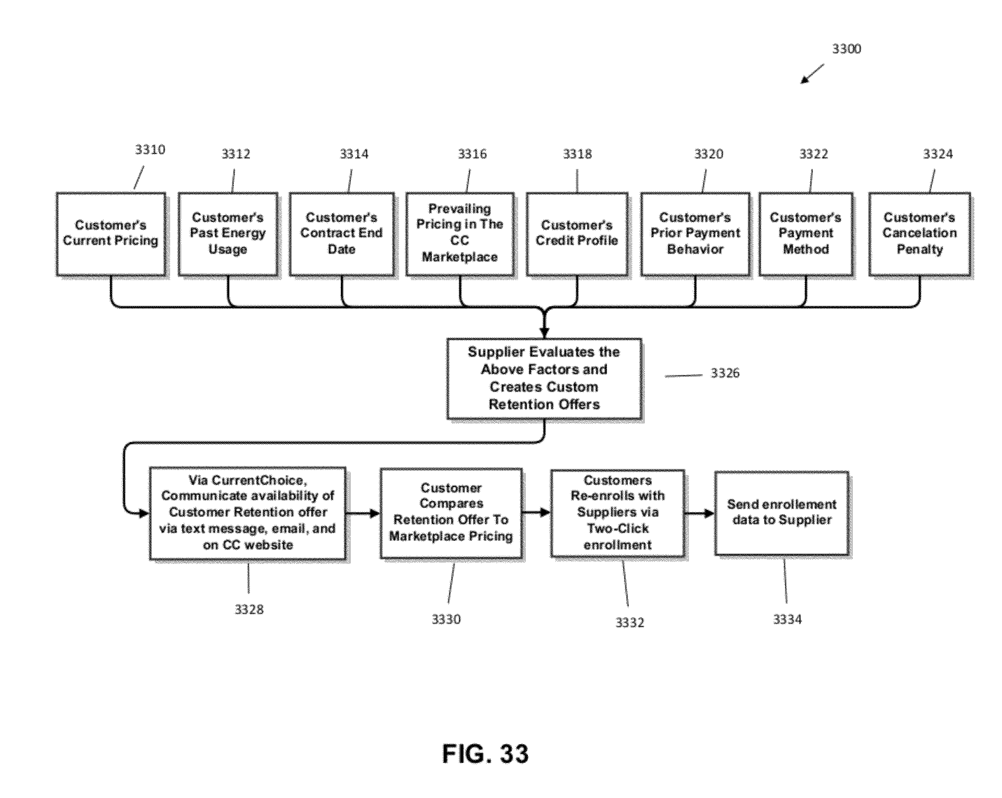

Referring to FIG. 33, with further reference to FIG. 3 and FIG. 28, a block diagram 3300 of an at risk manager code segment is shown. In an embodiment, the at risk manager code segment can be part of the supplier retention module 354. In general, the at risk manager code segment provides an application to enable suppliers to proactively protect their customer. The supplier retrieves customer and market attributes such as the customer's current pricing 3310, the customer's past energy usage 3312, the customer's contract end date 3314, the prevailing pricing in the market place 3316 (e.g., the pricing of other offers in the WA), the customer's credit profile 3318, the customer's prior payment behavior 3320, the customer's payment method 3322, and the customer's cancelation penalty 3324. The at risk manager code segment enables a supplier to view customers based on various combinations and constraints placed on this customer and market attributes. For example, the supplier can look at all of the customers in a region that are paying higher than the market place. Thus, if a particular high usage customer is identified as paying more than the market price, they may be considered at risk. With this information, the supplier can evaluate the attributes and create a custom retention offer for that customer at stage 3326. The customer offer can be sent to the customer at stage 3328, and subsequently reviewed, accepted, and acknowledged by the customer as previously discussed (i.e., stages 3330, 3332, 3334).

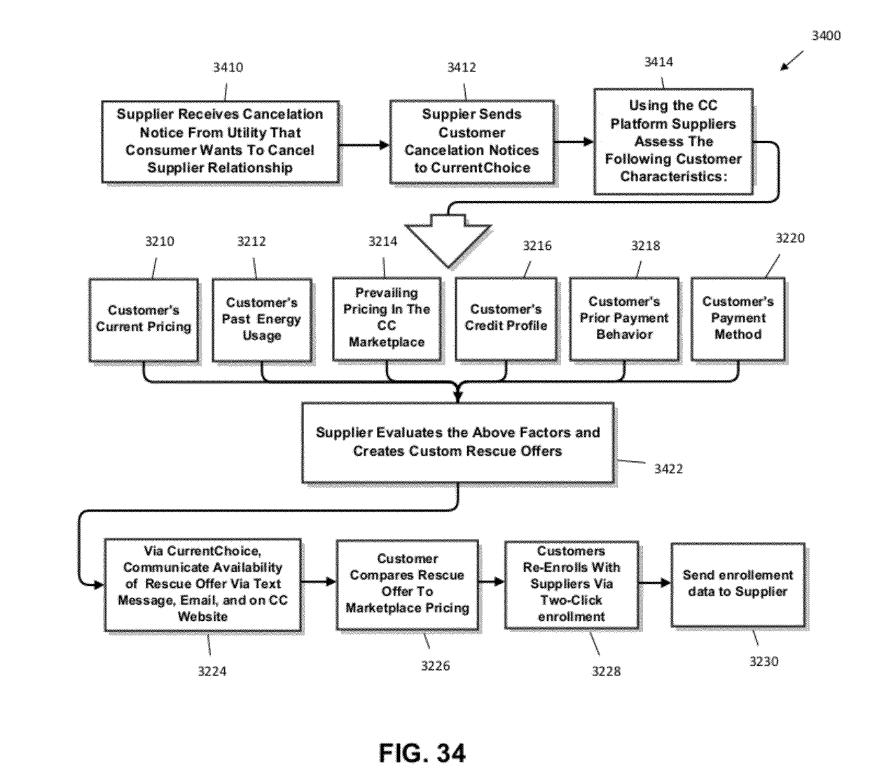

Referring to FIG. 34, with further reference to FIG. 3, FIG. 27 and FIG. 32, a block diagram 3400 of a cancelation manager code segment is shown. In an embodiment, the cancelation manager code segment can be part of the supplier retention module 354. In general, the cancelation manager code segment is used if a supplier receives a notification that a customer is going to cancel their relationship with the supplier. For example, at stage 3410 the supplier can receive a Form 814 from the utility indicating that the customer has canceled the relationship. At stage 3412, the supplier can enter the cancelation notice into the WA. The supplier can utilize the WA to assess the customer's attributes at stage 3414, and create a custom rescue offer at stage 3422 in a process that is similar to the contract renewal code segment 3200.

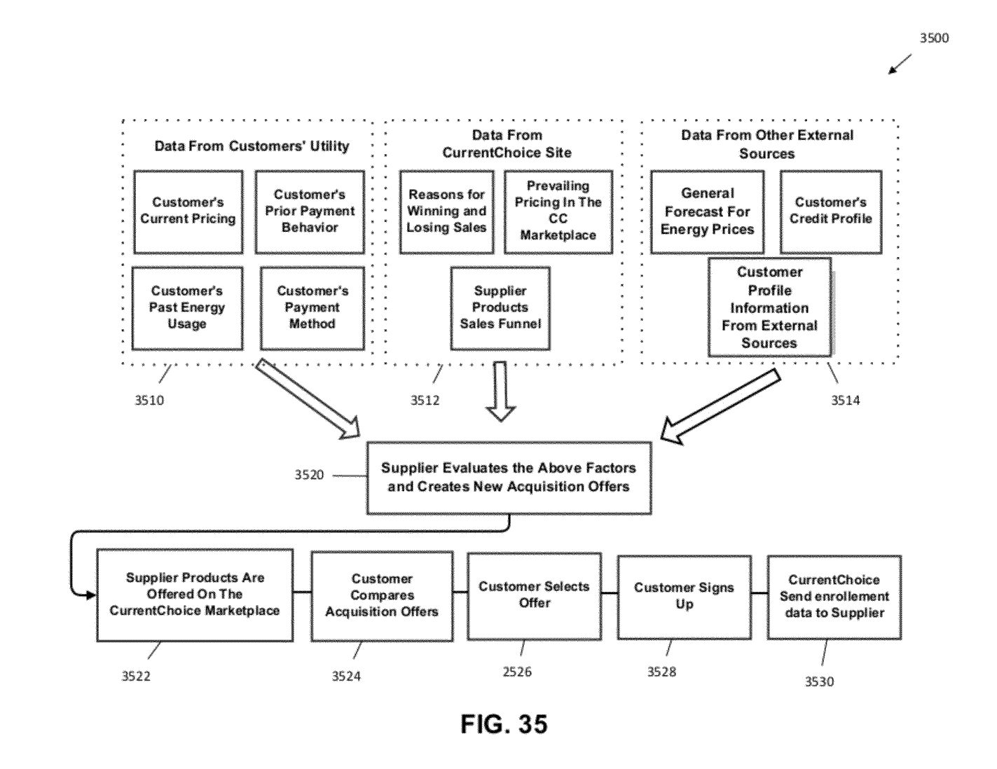

Referring to FIG. 35, with further reference to FIG. 3 and FIG. 29, a block diagram 3500 of an acquisition manager code segment is shown. In an embodiment, the acquisition manager code segment can be part of the supplier performance module 352. The acquisition manager code segment accesses data from a customer's utility 3510, data from the WA 3512, and data from other external sources 3514. For example, data from a customer's utility 3510 can include the customer's current pricing, the customer's past energy usage, the customer's prior payment behavior, and the customer's payment method. The data from the WA 3512 can include the reasons for winning and losing sales, the prevailing pricing in the marketplace (e.g., other offers within the WA, and data correlated in a supplier products sales funnel. The data from other external sources 3514 can include the general forecast for energy prices, the customer's credit profile, and customer profile information from external sources. This data can be used by the supplier at stage 3520 to create a new acquisition offers. For example, the supplier can create offers that are tailored for a particular customer profile (i.e., by region, by usage rate, temporal restraints). The WA helps enable the supplier to create many different offers to meet various market demands. In an embodiment, if customer's indicate their preference for a more environmentally concerned solution (e.g., from renewable sources) a more green energy product offering can be created. Similarly, a supplier can have the ability to create energy offers in view of external events that may create concerns in the market (i.e., oil spills, natural disasters, general forecast for energy prices). Such offers may lock in a price and a term and thus help alleviate the customer's concerns about escalating prices, or select a variable rate if they believe rates will fall.

At stage 3522, the offers created by the suppliers can be presented to one or more customers. The offers can be presented to the market as an A/B split, for example, to help correlate trends within the customer base. In an embodiment, offer A can be extended to a subset of customers (i.e., subset A), and offer B can be extended to another subset of customers (i.e., subset B). The offers can be valid for a finite duration of time. The success rate of individual offers can be compared and subsequent offers can be created to adjust to the corresponding market trends. At stage 3524 the customer can compare the offers from one or more of the suppliers. Referring to FIG. 22, the offers can be filtered and displayed based on the customer's input. At stage 3526, the customer can select an offer that meets their requirements. The customer can sign up for the offered plan at stage 3528, and the WA can provide the enrollment information to the supplier at stage 3530.

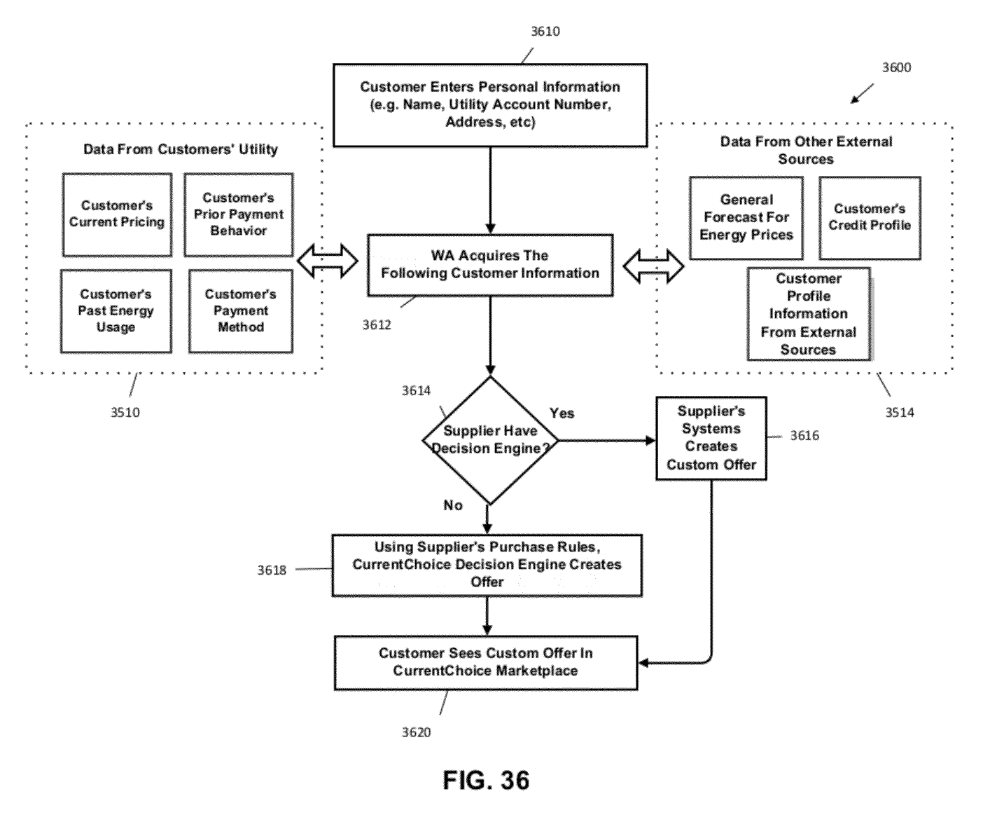

Referring to FIG. 36, with further reference to FIG. 3 and FIG. 35, a block diagram 3600 of a customized marketplace code segment is shown. In general, the customized marketplace code segment can be included in the supplier performance module 352. In general, the customized market place code segment allows for the automatic creation (i.e., via a decision engine) of a custom offer. At stage 3610, a potential customer can enter their personal information (e.g., name, utility account number, address, etc.). This information can be stored in the WA at stage 3612, along with data from the customer's utility 3510 and data from other external sources 3514. At stage 3614, a decision can be made based on whether or not a supplier has a decision engine. If the supplier has a decision engine, the supplier's system can create a custom offer based on the data at stage 3616. If the supplier does not have a decision engine, then the WA can utilize the suppliers rules in a WA decision engine to create an offer at stage 3618. The offer, or offers, can be presented to the customer at stage 3620.

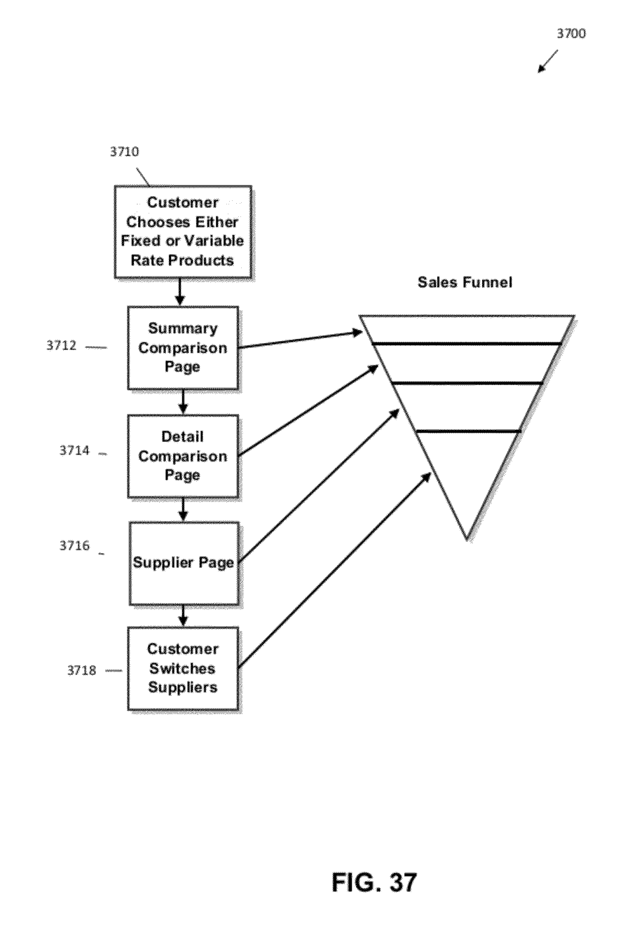

Referring to FIG. 37, with further reference to FIG. 3, FIG. 10 and FIG. 29, a conceptual diagram 3700 of a supplier produce sales funnel object is shown. In general, the sales funnel object can appear on the screens associated with the customer acquisition features of the WA (e.g, FIG. 10, FIG. 29). The sales funnel object displays the data associated with the actions completed by a potential customer before accepting or rejecting an offer. For example, at stage 3710, a customer can chose either fixed or variable rate products. The customer can narrow their focus at stage 3712, for example, to view a summary comparison of a plurality of supplier offers in the WA. At stage 3714, the potential customer can select a subset of the offers viewed in stage 3712 and view a detailed comparison of the offers. At stage 3716 the potential customer can view the supplier page, and at stage 3718, the potential customer can accept an offer from a supplier. The data for this progression can be captured and displayed as a funnel object. For example, referring to FIG. 29, a supplier can view a sales funnel for a particular offer, or a group of offers. The result can be an expression of the percentage of time the offer/offers are include in each of the stages (e.g., 40%, 20%, 20%). The sales funnel provides feed back to the suppliers in an effort to help them increase their customer acquisition rate.

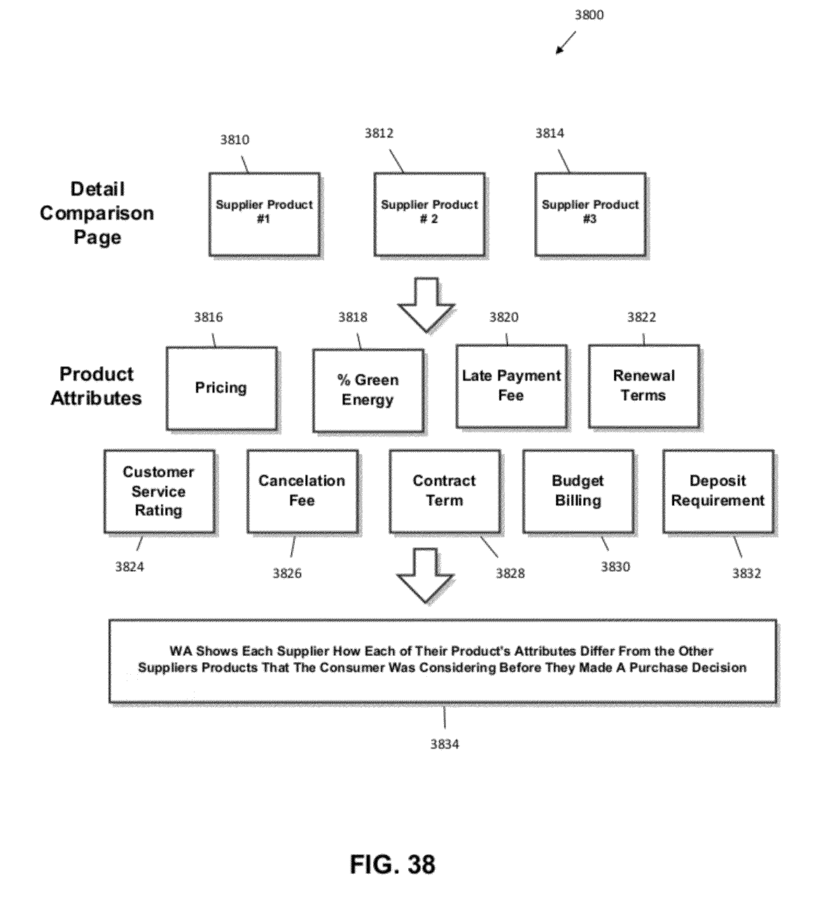

Referring to FIG. 38, with further reference to FIG. 29 and FIG. 35, a conceptual diagram 3800 of a winning and losing sales comparison code segment is shown. In general, the winning and losing sales comparison code segment can be included in the supplier performance module 352. The winning and losing sales comparison code segment can be used to highlight the product attributes associated with offers that are accepted or rejected by customers. For example, a collection of offers 3810, 3812, 3814 from one or more suppliers can be filtered (e.g., by state, by utility) and presented for comparison. Correlations between common attributes can be determined and presented (e.g., pie chart, bar graph, etc.). As an example, and not a limitation, key attributes can include pricing 3816, percentage of green energy 3818, late payment fee requirements 3820, renewal terms 3822, customer service rating 3824, cancelation fee 3826, contract term 3828, budget billing 3830, and deposit requirement 3832. At stage 3834 the WA can present to the supplier information associated with how each of the supplier's product attributes differ from other supplier products that the potential customers were considering before making their purchasing decisions.

Those skilled in the art will therefore understand that the embodiments disclosed herein are merely exemplary, and that various changes in form and detail may be made without departing from the scope of the invention. The application is not limited to the energy services market. For example, with reasonable modifications to the WA, other vertically integrated markets such as cellular telephone plans, cable and satellite television, vehicle leasing plans, and building maintenance plans can benefit from the claimed inventions.

What is claimed is:

1. A computer-implemented method for facilitating relationships among energy consumers and energy suppliers, including operating at least one processor to perform a method comprising:
communicating, over a computer network, with a consumer;
communicating, over the computer network, with a billing entity serving the consumer;
retrieving, over the computer network, consumer data from the billing entity serving the consumer, said consumer data pertaining to at least one of energy usage, timing of energy usage, and payment history; and
providing the consumer with a list of energy suppliers and associated contract terms for the provision of energy, wherein at least some of said contract terms are based on said retrieved consumer data.

2. The computer-implemented method of claim 1, wherein the step of retrieving comprises logging onto an account for the consumer at the billing entity, accessing consumer data about the consumer using the account at the billing entity, and storing the accessed data.

3. The computer-implemented method of claim 1, wherein the step of communicating with the consumer comprises receiving user information from the consumer, and the method further comprises applying at least some of said received user information from the consumer to create a local account for the consumer.

4. The computer-implemented method of claim 3, further comprising applying said received user information from the consumer to create an account for the consumer at the billing entity.

5. The computer-implemented method of claim 1, further comprising:
A) transmitting at least some of the consumer data for the consumer to at least one supplier;
B) receiving a quote from each at least one supplier for supplying energy to the consumer; and
C) transmitting the quote from each at least one supplier to the consumer.

6. The computer-implemented method of claim 1, wherein the step of providing the consumer with a list of energy suppliers and associated contract terms comprises:
transmitting at least some of said consumer data for the consumer to at least one of said suppliers of said list of suppliers;
receiving, from each at least one of said suppliers, an offer for the provision of energy to the consumer based on the consumer data for the consumer; and
presenting the offer from each at least one supplier to the consumer.

7. The computer-implemented method of claim 1, wherein the step of providing the consumer with a list of energy suppliers and associated contract terms comprises:
receiving, from at least one supplier of said list of suppliers, a set of rules for producing offers to consumers for the provision of energy;
applying the consumer data for the consumer to said set of rules for each at least one supplier, to produce an offer for the consumer from each at least one supplier; and
presenting the offer from each at least one supplier to the consumer.

8. The computer-implemented method of claim 1, further comprising presenting to the consumer an estimated savings that the consumer could experience by switching to a less expensive energy supplier.

9. The computer-implemented method of claim 8, wherein the estimated savings is calculated based upon a property location of the consumer and at least one of the following:
an average energy consumption of consumers in the consumer's location;
an actual cost paid by the consumer to the consumer's current supplier;
an actual amount of power consumed at the consumer's property;
a calculated estimate of the consumer's energy usage based upon characteristics of the consumer's property;
a cost of default power from a utility of the consumer; and
a least expensive rate charged by any supplier supplying power to consumers in the consumer's location.

10. The computer-implemented method of claim 9, wherein the estimated savings is computed by:
looking up the average consumption of properties in the consumer's property location;
looking up a default power rate provided in the consumer's property location;
identifying the best available rate from a supplier supplying power to the consumer's property location;
multiplying the default power rate by the average power consumption in the consumer's property location to produce a first product;
multiplying the best available rate by the average power consumption in the consumer's property location to produce a second product; and
subtracting the first product from the second product to obtain the estimated savings.

11. The computer-implemented method of claim 1 further comprising communicating, over the network, with a supplier to present information to the supplier pertaining to at least one of the supplier's history of acquiring new consumers, the supplier's history of retaining existing consumers, the supplier's customers that are at risk for attrition, customers that have sent a cancelation notice to the billing entity, reasons that supplier has won or lost a customer, and the volume of pending renewals.

12. A computer-implemented marketplace for energy consumers and energy suppliers, comprising:
a processor operatively connected to a computer network for communicating with consumers and suppliers over said computer network;
at least one database storing information about consumers and suppliers; and
application code running on the processor with access to the at least one database, the application code including
at least one consumer module constructed and arranged to present to consumer users of the marketplace information from said at least one database pertaining to a plurality of suppliers;
at least one supplier module constructed and arranged to present to supplier users of the marketplace information from said at least one database pertaining to a plurality of consumers; and
at least one billing entity module constructed and arranged to access, via said processor over said computer network, a billing entity of a consumer user of the marketplace, and to retrieve consumer data therefrom pertaining to said consumer user of the marketplace.

13. The computer-implemented marketplace of claim 12, wherein the billing entity comprises at least one of (i) a computer system of an energy utility of a consumer user of the marketplace and (ii) a computer system of a current supplier of a consumer user of the marketplace.

14. The computer-implemented marketplace of claim 13, wherein the at least one consumer module comprises an account creation module constructed and arranged to interactively communicate with the consumer user to obtain account information and to set up an account for the consumer user on the marketplace using said account information.

15. The computer-implemented marketplace of claim 14, wherein the at least one billing entity module comprises a billing entity account creation module constructed and arranged to create an account on behalf of a consumer user of the marketplace using said account information obtained by the account creation module.

16. The computer-implemented marketplace of claim 15, wherein the at least one billing entity module further comprises a data access module constructed and arranged to (i) log into the account created by the billing entity account creation module, for accounts created by the account creation module, and to obtain therefrom consumer data pertaining to the consumer user; and (ii) log into a user account at the billing entity, for accounts not created by the account creation module, and to obtain therefrom consumer data pertaining to the consumer user.

17. A non-transitory computer readable storage medium having computer-executable instructions which, when executed, carry out a method of facilitating relationships among energy consumers and energy suppliers, the method comprising:
communicating, over a computer network, with a billing entity of an energy consumer;
receiving, from the billing entity over the computer network, consumer data pertaining to the energy consumer; and
transmitting, over the computer network, at least a portion of said consumer data to at least one energy supplier.

18. The non-transitory computer readable storage medium of claim 17, wherein the consumer data comprises at least one of energy cost to the energy consumer, energy usage of the energy consumer, payment history of the energy consumer, and the identity of the current supplier of the energy consumer.

19. The non-transitory computer readable storage medium of claim 18, wherein said at least one supplier comprises a plurality of suppliers, and further comprising:
receiving a plurality of offers from the plurality of suppliers;
presenting the plurality of offers to the consumer; and
receiving a selection from the consumer identifying a selected supplier.

20. The non-transitory computer readable storage medium of claim 17, further comprising:
receiving a message directed to the consumer from a supplier of said at least one supplier; and
delivering the message to the consumer.

21. The non-transitory computer readable storage medium of claim 17, further comprising:
receiving authorization from the consumer to execute a contract with one of the suppliers based on the supplier's offer; and
sending the authorization to the supplier.

22. The non-transitory computer readable storage medium of claim 20, wherein said message comprises at least one of (i) a promotional offer, (ii) a blend and extend offer, (iii) a discounted renewal rate, (iv) an energy savings recommendation and (v) confirmation of contract execution.
